(19) United States
(12) Patent Application Publication
(10) Pub. No.: US 2011/0076479 A1
(43) Pub. Date: Mar. 31, 2011

(54) Process And Composition For Fabricating Non-Sewn Seams

(76) Inventors: David Lloyd Danielson, Midland, MI (US); Michael Dipino, North Branford, CT (US); Todd Starke, Merrill, MI (US); Randall Paul Sweet, Midland, MI (US)

(21) Appl. No.: 12/994,018

(22) PCT Filed: May 19, 2009
(86) PCT No.: PCT/US2009/044426

§ 371 Date: Nov. 22, 2010

(30) Foreign Application Priority Data
May 22, 2008 (US) 61055194

(51) Int. Cl. B32B 37/10; B32B 37/12

(52) U.S. Cl. 428/221; 156/60; 156/275.7; 156/329

(57) ABSTRACT

A silicone composition and process are used to form a non-sewn seam in an airbag for use in vehicle applications. The airbag has a seam made from a silicone material prepared from the silicone composition. The silicone material and the process for forming the airbag seam minimize the need for sewn seams.

### CROSS-REFERENCE TO RELATED APPLICATIONS

This application claims the benefit of U.S. Provisional Patent Application Ser. No. 60/873,799 filed on 6 Dec. 2006. U.S. Provisional Patent Application Ser. No. 60/873,799 is hereby incorporated by reference.

### BACKGROUND

1. Technical Field

The process and composition described herein are useful for assembling inflatable articles, including airbags useful in vehicle applications.

2. Problem to be Solved

Conventional airbags are made of coated fabrics. Panels forming the airbag and patches in the airbag are sewn together to provide sufficient mechanical strength. These airbags may be assembled by, for example, bonding a first panel and a second panel together with a silicone adhesive applied to the periphery of the panels and thereafter sewing the panels together with one or more seams of sewing thread or yarn. The seams are sewn through the silicone adhesive to provide sufficient gas imperviousness and/or pressure retention when the airbag is deployed. These properties result in a relatively time consuming and expensive process to assemble airbags, in which multiple steps are required to seal and sew seams. There is a need in the automotive industry to improve process efficiency for assembling airbags while maintaining other airbag properties.

### SUMMARY

A process for forming a non-sewn seam adhering textiles together is disclosed. The process comprises: surface treating a first surface of a first textile, applying a bead of an adhesive composition to the treated first surface, and contacting the adhesive composition with a second substrate or a second adhesive composition.

### BRIEF DESCRIPTION OF THE DRAWINGS

FIG. 1 shows an airbag prepared according to the methods of reference example 1 and 2 including a bead of seam sealant 104 and a bead of hot melt adhesive 102 between two coated fabric panels 100.

FIG. 2 is an alternative embodiment of an airbag including a second bead of hot melt adhesive 106.

FIGS. 3-8 show examples of alternative configurations of materials in a seam.

### DETAILED DESCRIPTION

### Definitions and Usage of Terms

All amounts, ratios, and percentages are by weight unless otherwise indicated. For purposes of this application, the articles ‘a’, ‘an’, and ‘the’ each refer to one or more. ‘Airbag’ means any inflatable article that can be filled with a gas such as air, helium, a hybrid gas mixture, or the gaseous products of inflator propellant combustion, and that is useful to protect an occupant of a vehicle in the event of an impact. ‘Surface treating’ means cleaning to remove contaminants and/or activating to create polar, reactive groups on the surface. ‘Surface treating’ includes, but is not limited to, ozone treating, plasma treating, corona treating, and flame treating.

When matter is continually supplied with energy, its temperature increases and it typically transforms from a solid to a liquid and, then, to a gaseous state. Continuing to supply energy causes the system to undergo a further change of state in which neutral atoms or molecules of the gas are broken up by energetic collisions to produce negatively charged electrons, positive or negatively charged ions and other species. This mix of charged particles exhibiting collective behavior is called “plasma”. Due to their electrical charge, plasmas are highly influenced by external electromagnetic fields which make them readily controllable. Furthermore, their high energy content allows them to achieve processes which are impossible or difficult through the other states of matter, such as by liquid or gas processing.

The term “plasma” includes many systems having density and temperature varying by many orders of magnitude. Some plasmas are hot and all their microscopic species (ions, electrons, etc.) are in approximate thermal equilibrium, the energy input into the system being widely distributed through atomic/molecular level collisions. Other plasmas, however, particularly those at low pressure (e.g., on the order of 100 Pa) where collisions are relatively infrequent, have their constituent species at widely different temperatures and are called “non-thermal equilibrium” plasmas. In these non-thermal equilibrium plasmas, the free electrons have temperatures of many thousands of degrees Kelvin while the neutral and ionic species remain cooler. Because the free electrons have almost negligible mass, the total system heat content is low and the plasma operates close to room temperature, thus allowing the processing of temperature sensitive materials, such as plastics or polymers, without imposing a damaging thermal burden onto the substrate. However, the hot electrons create, through high energy collisions, a rich source of radicals and excited species with a high chemical potential energy capable of profound chemical and physical reactivity. It is this combination of low temperature operation plus high reactivity which makes non-thermal plasmas a useful tool for surface treating.

For industrial applications of plasma technology, a convenient method is to couple electromagnetic power into a volume of process gas which can be mixtures of gases and vapors in which the substrates to be surface treated are immersed or passed through. This is achieved by passing a process gas through a gap between adjacent electrodes across which a large potential difference has been applied. A plasma is formed in the gap (hereafter referred to as the plasma zone) by the excitement of the gaseous atoms and molecules caused by the effects of the potential difference between the electrodes. The gas becomes ionized in the plasma, thereby generating chemical radicals, UV-radiation, excited neutrals and ions, which react with the surface of the substrate. The glow generally associated with plasma generation is caused by the excited species giving off light when returning to a less excited state. By correct selection of process gas composition, driving power frequency, power coupling mode, pressure and other control parameters, the plasma process can be tailored to the specific application required by the manufacturer.

‘Plasma treating’ means exposing the surface to a gaseous state activated by a form of energy externally applied and includes, but is not limited to, plasma jet, dielectric barrier discharge, low pressure glow discharge, atmospheric glow discharge treatment, and liquid precursor plasma. ‘Plasma treating’ includes applying a liquid precursor to the surface in the plasma stream and depositing in molecular fragments, as whole molecules, or as a molecular film which is then polymerized on the surface.

‘Corona treating’ means exposing the surface to a locally intense electric field, i.e., non-uniform electric fields generated using point, edge and/or wire sources are conventionally described as corona discharge systems. Corona discharge systems typically operate in ambient air resulting in an oxidative deposition environment. The design of corona discharge systems is such as to generate locally intense discharges which result in variations in energy density across the process chamber.

‘Flame treating’ means exposing the surface to a thermal equilibrium plasma. Flame treating systems operate at high gas temperature and are oxidative by nature.

‘Ozone treating’ means forming triatomic oxygen, which can be produced by passing dry air between two plate electrodes connected to an alternating current. Ozone can form ozonides, which are useful oxidizing compounds.

The gas used for surface treating can be air, ammonia, argon, carbon dioxide, carbon monoxide, fluorine, Freon, helium, hydrogen, krypton, mercury vapor, neon, nitrogen, nitrous oxide, oxygen, ozone, sodium vapor, water vapor, xenon, and combinations thereof. Alternatively, other more reactive gases or vapors can be used, either in their normal state of gases at the process application pressure or vaporized with a suitable device from otherwise liquid states, such as hexamethyldisiloxane, cyclopolydimethylsiloxane, cyclopolyhydrogenmethylsiloxanes, cyclopolyhydrogenmethyl-co-dimethylsiloxanes, reactive silanes, and combinations thereof. Alternatively, nebulized droplets of such liquids may be used in certain plasma treating systems.

### Process for Forming a Non-Sewn Seam

The process for forming a non-sewn seam in an airbag may comprise: i) surface treating a surface of a textile, thereby creating a treated surface, ii) applying a bead of an adhesive composition to the treated surface, iii) contacting the bead with a second bead of a second adhesive composition or with a second surface of a second textile, and iv) forming a non-sewn seam of adhesive material from the bead of the adhesive composition. The process may optionally further comprise v) post curing the airbag.

The process may further comprise treating the second surface of the second airbag component before step iii). The second surface may be treated using the same or a different surface treatment than the first surface.

One bead of one composition may be used in the process to form the non-sewn seam. Alternatively, the process may further comprise applying a second bead to the treated first surface or the treated second surface before step iii). When present, the second bead may have a different composition and/or configuration from the bead formed in step ii).

The process may optionally further comprise applying an adhesion promoter to the first surface before step i) or before step ii), applying an adhesion promoter to the second surface before step iii), or both. The adhesion promoter may be applied by any convenient means, such as dissolving or dispersing the adhesion promoter in a solvent to form a solution and thereafter contacting with the solution, at least one surface of the airbag component to which the composition will be applied. Applying the solution may be performed by, for example, by spraying, dipping, or brush coating. Examples of suitable adhesion promoters are described below (as ingredient (V)), and examples of suitable solvents are described below (as ingredient (VII)). The adhesion promoter may be coated on the surface. Alternatively, the adhesion promoter may be applied in a defined area of the surface, e.g., an area corresponding to where the non-sewn seam will be formed.

The process may optionally further comprise: coating the first surface with a rubber, coating the second surface with a rubber, or both before surface treating in step i). The surface(s) may be coated before surface treating said surface(s) and before or after application of an adhesion promoter, if used. The rubber can be a silicone rubber or a silicone modified organic rubber. For example, the rubber may be formed by a method including applying to a surface, a silicone emulsion, a (solvated or unsolvated) high consistency rubber, a liquid silicone rubber composition, an aerosolized silicone rubber, a powdered silicone rubber or a melted silicon resin.

When the process is used in an airbag application, the first and second textiles may be airbag components, and the airbag components may be prepared before step i) by a method including coating a fabric with a fabric coating composition, such as DOW CORNING® LCF 3600, by introducing the composition in the form of an aerosol of liquid droplets into an atmospheric plasma discharge or the excited species resulting therefrom. Alternatively, the fabric coating can be introduced into the plasma discharge or resulting stream in the absence of a carrier gas, i.e., introduced directly by, for example, direct injection, whereby the fabric coating is injected directly into the plasma. PCT Publication WO 2002/28548, which is hereby incorporated by reference, discloses a process and equipment that may be used to prepare such an airbag component. In this method, steps i) and ii) may be performed concurrently.

Forming the non-sewn seam in step iv) may be performed by cooling the adhesive composition, curing the adhesive composition, or both, to form an adhesive material. The method for forming the adhesive composition into the non-sewn seam depends on various factors including the type of adhesive composition and its method of application. When more than one adhesive composition is used in an airbag application, the non-sewn seam may comprise a first adhesive material made from a first adhesive composition and a second adhesive material made from a second adhesive composition. The first adhesive material is located toward the interior of the airbag, the second adhesive material is located toward the exterior of the airbag, and the first adhesive material and the second adhesive material may contact each other. The first and second adhesive materials may differ in hardness, modulus, or both.

Alternatively, the process may comprise:
i) surface treating a first surface of a first textile to form a treated first surface,
ii) applying a first bead of a first silicone composition to the treated first surface the first textile,
iii) contacting the first bead of the first silicone composition with a second surface of a second textile, and
iv) forming a non-sewn seam comprising a first silicone material from the first silicone composition,
   thereby adhering the first textile and the second textile through the non-sewn seam. One or more beads of silicone composition may be used. When more than one bead is used, the beads may be applied adjacent to each other on the first surface before step iii), or the first bead may be applied on the first surface, and the second bead may be applied on the second surface, such that the beads are adjacent to each other in step iii).

Alternatively, the process may comprise:
1) surface treating a first surface of a first textile to form a treated first surface, surface treating a second surface of a second textile to form a treated second surface, or both;
2) applying a first bead of a first silicone composition to the treated first surface the first textile;
3) applying a second bead of a second silicone composition to the treated second surface;
4) contacting the first bead and the second bead to form one bead; and
5) forming a non-sewn seam from the one bead; thereby adhering the first textile and the second textile through the non-sewn seam. In this process, the first silicone bead has a first exposed surface opposite the first treated surface, the second bead has a second exposed surface opposite the second treated surface, and step iv) is performed by contacting the first exposed surface and the second exposed surface. A portion of the silicone composition may be applied to each substrate such that aligning the first bead and the second bead in step iv) forms a thicker bead. The first silicone composition and the second silicone composition may be the same or different. Step v) may be performed by curing the first silicone composition and the second silicone composition concurrently.

Alternatively, more than one bead may be used, and the process may comprise:
1) surface treating a first surface of a first textile to form a treated first surface;
2) surface treating a second surface of a second textile to form a treated second surface;
3) applying a first bead of a first silicone composition to the treated first surface;
4) applying a second bead of a second silicone composition to the treated first surface or the treated second surface, such that the second bead is adjacent the first bead during or after step 5); and
5) forming a non-sewn seam from the product of step iv), thereby adhering the first textile and the second textile together.

Alternatively, the process may be performed using only one bead. The process may comprise:
i) surface treating a first surface of a first textile to form a treated first surface, surface treating a second surface of a second textile to form a treated second surface, or both;
ii) applying one bead of silicone composition to the treated first surface;
iii) contacting the one bead with the treated second surface; and
iv) forming a non-sewn seam from the bead, thereby adhering the first textile and the second textile together.

Alternatively, the process may comprise:
i) surface treating a first surface of a first textile to form a treated first surface;
ii) surface treating a second surface of a second textile to form a treated second surface;
iii) applying one bead of silicone composition to the treated first surface; and
iv) compressing the one bead between the treated first surface and the treated second surface;
   thereby forming a non-sewn seam adhering the first textile and the second textile together.

The process described herein is useful for making a non-sewn seam. The non-sewn seam may be used in various applications, such as tents, awnings, inflatable toys, rafts, safety chutes for aircraft, automobile soft tops, architectural fabrics, banners, conveyor belting applications, and airbags. Alternatively, the non-sewn seam may find use in an airbag. The first textile may comprise a first airbag component, and the second textile may comprise a second airbag component. The first airbag component and the second airbag component may each independently be selected from panels or patches.

### Step i) Surface Treating

Surface treating may be performed by any convenient means. Surface treating may be performed by flame treating, alternatively corona treating, alternatively ozone treating, and alternatively plasma treating. Flame treating or corona treating may be used to minimize cost. Alternatively, plasma treating may be used. Alternatively, more than one plasma treating step may be used to improve adhesion.

In the processes described herein, surface treating may be performed concurrently on the first surface of the first textile and the second surface of the second textile. The same surface treatment may be used on both the first and second surfaces. Alternatively, different surface treating methods may be used on the first surface and the second surface.

Various methods of plasma treating may be used for treating surfaces of textiles in the process described above. For example, plasma jet, dielectric barrier discharge treatment, and glow discharge treatment can be used. Glow discharge treatment can be carried out using plasma selected from low pressure glow discharge or atmospheric pressure glow discharge.

For example, plasma treating may be performed by low pressure glow discharge plasma in either continuous or pulsed modes. This can be a batch process. Alternatively, plasma treating may be performed at atmospheric pressure in a continuous process using appropriate atmospheric plasma apparatuses. Plasma treating is known in the art. For example, U.S. Pat. Nos. 4,933,060 and 5,357,005 and T. S. Sudarshan, ed., Surface Modification Technologies, An Engineer's Guide, Marcel Dekker, Inc., New York, 1989, Chapter 5, pp. 318-332 and 345-362, disclose exemplary methods.

The exact conditions for plasma treatment will vary depending on various factors including the choice of airbag components the storage time between plasma treating and contacting; the type and method of plasma treating used; and design of the plasma chamber used. However, plasma treating can be carried out at a pressure up to atmospheric pressure. Alternatively, plasma treating can be carried out at a pressure of ranging from 0.05 torr to 10 torr, alternatively 0.78 ton to 3 torr, and alternatively 1.5 torr to 3 torr.

Time of plasma treating depends on various factors including the airbag component to be treated, the contact conditions selected, the mode of plasma treating (e.g., batch vs. continuous), and the design of the plasma apparatus. Plasma treating is carried out for a time sufficient to render the surface of the airbag component to be treated sufficiently reactive to form an adhesive bond. Plasma treating may be carried out for a time ranging from 1 millisecond to 30 minutes, alternatively 0.002 second to 1 minute, alternatively 0.1 second to 30 seconds, and alternatively 1 second to 1 minute, and alternatively 5 seconds to 30 seconds. It may be desirable to minimize plasma treating time for commercial scale process efficiency. Treating times that are too long may render some treated airbag components nonadhesive or less adhesive.

The gas used in plasma treating can be, for example, air, ammonia, argon, carbon dioxide, carbon monoxide, helium, hydrogen, nitrogen, nitrous oxide, oxygen, ozone, water vapor, and combinations thereof. Alternatively, the gas can be selected from air, argon, carbon dioxide, carbon monoxide, helium, nitrogen, nitrous oxide, ozone, water vapor, and combinations thereof. Alternatively, the gas can be selected from air, argon, carbon dioxide, helium, nitrogen, ozone, and combinations thereof. Alternatively, other more reactive organic gases or vapors can be used, either in their normal state of gases at the process application pressure or vaporized with a suitable device from otherwise liquid states, such as hexamethyldisiloxane, cyclopolydimethylsiloxane, cyclopolyhydrogenmethylsiloxanes, cyclopolyhydrogenmethyl-co-dimethylsiloxanes, reactive silanes, and combinations thereof.

One skilled in the art would be able to select appropriate plasma treating conditions without undue experimentation using the above guidelines and the examples set forth below. Surface treating and applying the adhesive composition to the treated surface may be performed sequentially or concurrently, depending on the method of surface treating selected.

Step ii) may be performed immediately following step i). Alternatively, the textiles may optionally be stored for up to 24 hours before step ii), alternatively 4 to 12 hours, and alternatively 1 to 10 hours. Without wishing to be bound by theory, it is thought that storing for 24 hours or less provides the benefits of both surface cleaning and surface activation. Alternatively, the textiles may optionally be stored for more than 24 hours, for example, up to 14 days, alternatively up to 7 days before step ii). Without wishing to be bound by theory, it is thought that storing for more than 24 hours may provide a benefit of surface cleaning to improve adhesion. Alternatively, the adhesive composition may be treated as it is dispensed immediately before contact with the textile. For example, the adhesive composition may be dispensed through a plasma field immediately before contact with the textile.

### Step ii) Applying the Adhesive Composition

The method for applying the bead of the adhesive composition depends on various factors including the type of adhesive composition selected and the customer's desire. For example, applying the bead of adhesive composition may be performed using an extruder, for example, when the adhesive composition is an HCR composition. Alternatively, applying the bead may be performed using heated dispensing equipment, for example, when the adhesive composition is a hot melt composition or an HCR composition. Alternatively, applying the bead may be performed using robotic dispensing equipment, for example, in a method where a multiple part adhesive composition is used, and the parts may be mixed shortly before applying. Alternatively, the adhesive composition may be fabricated into a tape, and step ii) may be performed by applying the tape to the treated surface of the textile.

When more than one adhesive composition is used, the adhesive compositions may be applied concurrently or sequentially in any order. For example, when a curable sealant composition and a hot melt composition are applied to the same textile (such as an airbag component) in step ii), the curable sealant composition may be applied first, and thereafter the hot melt composition may be applied in contact with the curable sealant composition or spaced apart a small distance from the curable sealant composition. The exact distance may vary depending on the sealant composition and hot melt composition selected; however, the distance is sufficiently small that the hot melt adhesive and seam sealant are in contact with one another after step iii). In one embodiment, there are no gaps between the seam sealant and the hot melt adhesive. For example, the a curable sealant composition may be applied as a first continuous uniform bead, and the hot melt composition may be applied as a second continuous uniform bead; and the seam sealant and hot melt adhesive form one bead before step iv).

The exact configurations of the bead will depend on various factors including the inflatable article, such as a specific airbag design selected. However, for airbag applications, the width of the bead of may be sufficient to provide a bead of adhesive material that may range from 6 millimeters (mm) to 12 mm, alternatively 6 mm to 10 mm, and alternatively 3 mm to 15 mm. The depth of the bead of curable adhesive composition is sufficient to provide a bead of cured adhesive that may range from 0.4 mm to 1 mm, alternatively 0.6 mm to 0.8 mm, and alternatively 0.3 mm to 1.5 mm. The bead of hot melt adhesive may have the same dimensions as the bead of seam sealant.

Alternatively, step ii) may be performed by applying a template to the bead to form the bead into a desired shape, and thereafter removing the template. This may be useful in airbag applications.

The process may further comprise applying a second airbag component to the curable sealant composition and the hot melt composition before step iv), for example, when the curable sealant composition and the hot melt composition are applied to the same airbag component in step ii). Applying the second airbag component may cause the bead of curable sealant composition and the bead of hot melt composition to contact each other, if the beads were spaced apart from one another during application. Contacting the second airbag component with the composition may be performed by any convenient means. For example, a first panel having a first coated surface may be used in step ii), and a second panel having a second coated surface may be used in step ii), where the curable sealant composition and hot melt composition contact the coated and treated surfaces of the panels.

Alternatively, one skilled in the art would recognize that the curable sealant composition may be applied to a treated first surface of a first airbag component and the hot melt composition may be applied to a treated second surface of a second airbag component. Thereafter, the first and second airbag components may be combined such that the curable sealant composition and the hot melt composition contact each other.

Alternatively, the curable sealant composition may be applied to a first airbag component, such as a bottom panel, in step ii); and the hot melt composition may be applied to a second airbag component, such as a top panel, in step ii). The process may further comprise optionally cooling the hot melt composition before step iv). Without wishing to be bound by theory, it is thought that allowing the hot melt to cool may aid in the compressing of the hot melt composition into the curable sealant composition, forcing the lower viscosity curable sealant composition away from the surface of the bottom panel. This process can be applicable regardless of the configuration of the hot melt distribution whether it is continuous (e.g., straight, curved or zigzag) or as segmented shapes (such as beads).

After step iii), the top panel can be oriented to the bottom panel and compressed to a thickness that may range from 0.5 mm to 1.2 mm, to improve contact between composition and coated surfaces of the airbag components.

Application of the hot melt in a segmented pattern, for example, as shown in FIGS. 5-8, may be performed by applying the hot melt composition first, cooling it, and thereafter placing the curable sealant composition over the hot melt adhesive prepared by cooling the hot melt composition. Alternatively, a hot melt adhesive prepared by cooling the hot melt composition may be formed into discrete shapes such as beads and the beads may be inserted into the curable sealant composition. The contacting step would then push the beads of hot melt adhesive through the curable sealant composition and provide contact on both surfaces of the airbag components.

The process may optionally further comprise applying a third composition to the airbag component before step iii). For example, when the first composition is a curable sealant composition, the second composition is a hot melt composition, a second bead of hot melt composition may be applied to the airbag component before step iii) and before applying the second airbag component. The second bead of hot melt composition may be a different hot melt composition than the hot melt composition applied previously. For example, the curable sealant composition (interior), first bead of hot melt composition (which cures to form a first hot melt adhesive having a first modulus and a first elongation), and second bead of hot melt composition (which cures to form a second hot melt adhesive having a higher modulus, a lower elongation, or both, as compared to the first hot melt adhesive) may be used. Alternatively, the bead of seam sealant can be surrounded by hot melt adhesive beads on either side.

The process may further comprise cooling the hot melt composition after it is applied to the airbag component. Without wishing to be bound by theory, it is thought that cooling the hot melt composition may improve green strength of the airbag, thereby allowing for reducing assembly time and cost. When a noncurable hot melt composition is used, cooling may be performed to form the hot melt adhesive.

### Step iii) Contacting the Bead

Step iii) may be performed by any convenient means to improve wetting of the treated surface with the adhesive composition. Step iii) may be performed by exposing the textile, or the bead, or both to an energy wave or contact with a vibratory device. The energy wave can be contact (e.g., a roller) or non-contact (e.g., sound waves or ultra-high frequency waves). Alternatively, step iii) may be performed using a tool to follow a path of the bead to contact the treated second surface with the bead. Alternatively, step iii) may be performed by using a device, such as a wheel or squeegee, incorporating energy waves, such as ultrasound, or other vibratory device.

Alternatively, step iii) may be performed by pressing the second surface onto the bead, for example, in a hydraulic press. Conditions in the press will vary depending on the textiles and adhesive composition selected, however, for example, in an airbag application, step iii) may be performed by compressing the airbag components to form a compressed article. For example, the airbag components may be compressed between plates of the press at 1 to 20,000 psig, alternatively 1 to 500 psig, and alternatively 100 to 300 psig. The compressed article described above may be contacted with a heated substrate, such as a hot plate, at a temperature ranging from 70° C. to 200° C., alternatively 70° C. to 120° C. and allowing one surface of the compressed article to contact the hot plate for a time ranging from 90 seconds (s) to 600 s. (Steps iii) and iv) may optionally be performed concurrently. For example, the one of the plates in the hydraulic press described above may be heated. Alternatively, both of the plates in the hydraulic press may be heated. Alternatively, step iii) may be performed after step iv).) For example, curing the curable sealant composition to form a seam sealant may be performed by heating on a hot plate at a temperature of 70° C. to 200° C. for 3 minutes to 5 minutes. Alternatively, when the hot melt composition is contacted with the curable sealant composition, heat from the hot melt composition may initiate cure of the curable sealant composition. Without wishing to be bound by theory, it is thought that these methods of heating provide a benefit of reducing bubble formation thereby improving contact of the seam sealant and hot melt adhesive with the air bag component, as compared to heating methods involving heating all sides at once, for example, by placing the compressed article in an oven or heated press.

### Step iv) Forming a Non-Sewn Seam

The adhesive composition may be cured to form the non-sewn seam. For example, the adhesive composition may cure by exposure to heat at conditions such as those described above, when a hydrosilylation reaction curable composition, peroxide curable composition, or organo-borane curable composition is used, or exposure to moisture present as humidity in ambient air, when a condensation reaction curable composition is used. Alternatively, a dual cure system could be used, for example, a curable composition that is both hydrosilylation and peroxide curable could be used; and alternatively a curable composition that is both hydrosilylation and moisture curable may be used.

The adhesive composition may optionally be cured in a confined die. Without wishing to be bound by theory, it is thought that confined curing in step iv) may improve wetting of the treated surfaces as compared to unconfined curing.

Alternatively, the adhesive composition may be cured by a method comprising exposing the composition to microwave energy. When a hot melt composition is used, the non-sewn seam may be formed by cooling the hot melt composition, curing the hot melt composition, or both.

The exact conditions for forming the non-sewn seam depend on various factors including the adhesive composition and textiles selected. For example, in an airbag application, step iv) may be performed by heating at a temperature ranging from 60° C. to 190° C. One skilled in the art would recognize that these conditions are exemplary and not limiting. For example, certain airbag panels may be made of Nylon, which can degrade at temperatures exceeding 190° C., therefore, the upper limit of this range may be changed if a different textile is used. Higher temperatures may be used if fiberglass is used as the textiles. Alternatively, steps iii) and iv) may be performed concurrently by placing the second textile onto the bead to form an article, placing the article onto a heated substrate at a temperature ranging from 60° C. to 190° C., and compressing the article for 30 seconds to 10 minutes. One skilled in the art would recognize that these conditions are exemplary and not limiting.

### Step v) Post Curing

The process may optionally further comprise post curing the product of step iv) (e.g., airbag). The conditions for post curing will vary depending on the cure mechanism of the adhesive composition. For example, post curing a condensation reaction curable composition may comprise exposure to humid air. Alternatively, post curing could be by confined or unconfined heating, compression, or both, for example when a hydrosilylation curable composition is used.

For example, the airbag may be compressed, for example between hot plates at temperatures ranging from 90° C. to 185° C., alternatively 90° C. to 125° C. for 30 seconds to 5 minutes, alternatively 30 seconds to 90 seconds. The pressure may vary from 1 to 20,000 psig, alternatively 1 psig to 500 psig, and alternatively 100 to 300 psig. Without wishing to be bound by theory, it is thought that if pressure is too high in the post curing step, pressure retention may decrease when the airbag is deployed. Without wishing to be bound by theory, it is thought that when a seam sealant is used, the seam sealant acts as a cushion during compression and allows a curable hot melt composition or HCR composition to reach a fully or partially cured state.

The process may be used to form seams on airbags that are peripheral seams, interior seams, or both. Alternatively, the process may be used to form peripheral seams (seam around the periphery) on airbags. The process described herein employing both the seam sealant and the hot melt adhesive may eliminate the need for sewing one or more of the seams. For example, the process of this invention may be used to prepare a peripheral seam to form the bag while an interior seam, for example to form compartments within the airbag, may be sewn.

### Adhesive Materials

The adhesive material prepared from the adhesive composition in step iv) used to form the non-sewn seam may be organic or silicone adhesive material. Suitable organic adhesive materials include polyurethanes. Alternatively, the adhesive material used to form the non-sewn seam may be a reaction product of a curable silicone composition such as a seam sealant, a hot melt adhesive, a high consistency rubber (HCR), a liquid silicone rubber or a combination thereof. One adhesive material may be used to form the seam. For example, one HCR may be used to form the seam. Alternatively, more than one adhesive material may be used to form the seam. The adhesive compositions may be combined before, during, or after curing. For example, a liquid silicone rubber composition and an HCR composition may be combined before curing.

Alternatively, more than one bead of adhesive composition may be applied and used to form the adhesive material of the non-sewn seam. When more than one adhesive material is used, the adhesive materials may contact one another to form the seam. The adhesive materials may differ in hardness, modulus, or both. The adhesive materials may comprise a seam sealant and a hot melt adhesive. Alternatively, the adhesive materials may comprise two or more hot melt adhesives that differ in at least one of the following properties: modulus and elongation. Alternatively, the adhesive materials may comprise a seam sealant and a HCR. Alternatively, the adhesive materials may comprise two or more HCR's that differ in at least one of the following properties: modulus, elongation, or tear strength. Without wishing to be bound by theory, it is thought that when more than one adhesive material is used to form the non-sewn seam in an airbag, the adhesive material closest to the exterior of the airbag may have modulus at least 0.01% higher than the adhesive material closest to the interior of the airbag; the adhesive material closest to the exterior of the airbag may have a hardness at least 0.01% higher than the hardness of the adhesive material closest to the interior of the airbag; or both. Alternatively, when two hot melt adhesives are used, the hot melt adhesive closest to the exterior of the airbag may have an elongation at least 0.01% lower than the elongation of the hot melt adhesive closest to the interior of the airbag.

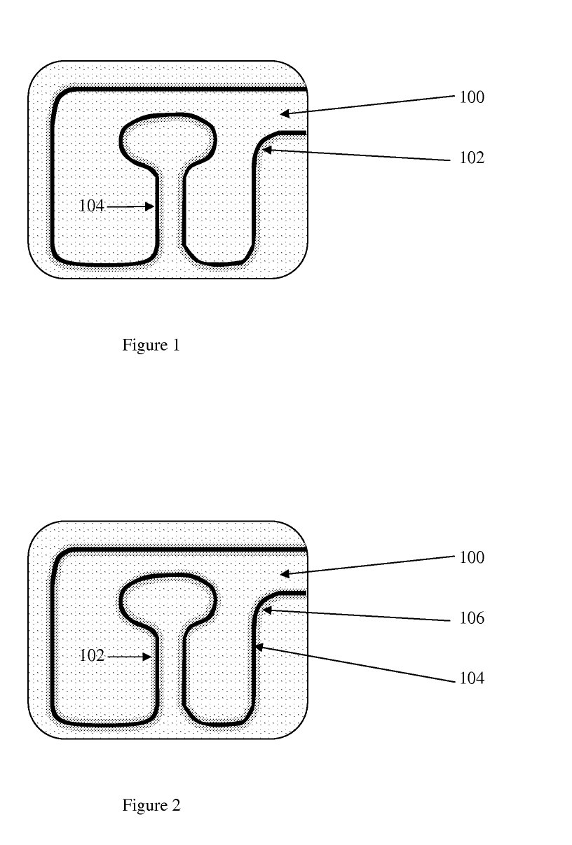

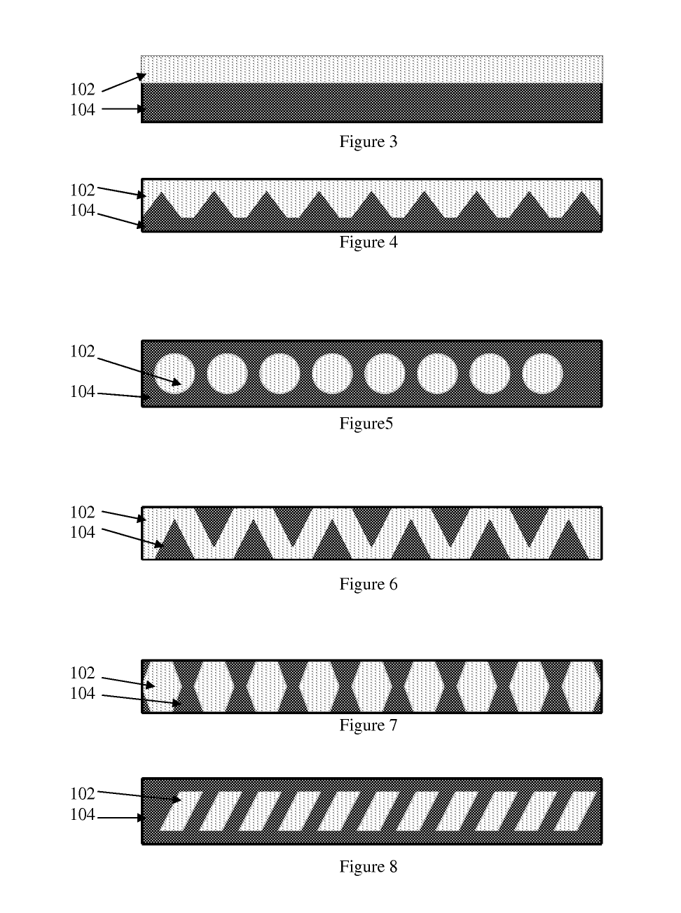

The adhesive materials may have different configurations. FIGS. 3-8 show different configurations for the materials, for example, when a seam sealant and a hot melt adhesive are used. For example, a continuous, uniform bead of seam sealant 104 and a continuous, uniform bead of hot melt adhesive 102 may be juxtaposed around the perimeter of an airbag such that the bead of seam sealant is on the interior of an airbag and the bead of hot melt adhesive contacts the seam sealant on the exterior of the airbag, as shown in FIGS. 1 and 3. Alternatively, the bead of seam sealant 104 and the bead of hot melt adhesive 102 may be tapered such that more seam sealant is toward the interior of the bag and more hot melt adhesive is toward the exterior, as shown in FIG. 4. Alternatively, hot melt adhesive 102 may be segmented into discrete shapes, such as beads or rivets (FIG. 5) or squares, parallelograms (FIG. 8), or trapezoids, within a continuous bead of seam sealant 104, as shown in FIGS. 5 and 8. Alternatively, the seam sealant 104 may be discontinuous triangular sections surrounding a continuous zigzag shaped bead of hot melt adhesive 102, as shown in FIG. 6. Alternatively, the seam sealant 104 and the hot melt adhesive 102 may both be discontinuous, as shown in FIG. 7. Without wishing to be bound by theory, it is thought that a discontinuous hot melt adhesive (e.g., formed into discrete shapes) with either a continuous or discontinuous seam sealant may provide the advantage of improved fold-ability in some airbags as compared to a similar airbag with a continuous bead of hot melt adhesive. One skilled in the art would recognize that FIGS. 1-8 are exemplary and not limiting; for example, two different materials could be used (e.g., substituting a HCR for the hot melt adhesive 102 shown in FIGS. 1-8 or substituting a second hot melt adhesive for the seam sealant 104 in FIGS. 1-8). Furthermore, different configurations could be used than the configurations in FIGS. 3-8, or the configurations shown in FIGS. 3-8 could be modified by applying two compositions to the coated surface of one airbag component in a configuration shown in one of FIGS. 3-8 and thereafter putting a second airbag panel on top of the compositions in the process for assembling the airbag.

### Adhesive Composition

The form of the adhesive composition used in the process described above depends on various factors including the method of applying the adhesive composition. The adhesive composition can be a commercially available silicone or organic (e.g., polyurethane) adhesive material such as PL®, which is a polyurethane sealant commercially from OSI Sealants, Inc. of Mentor, Ohio, U.S.A., or Liquid Nails®, which can be a styrene butadiene copolymer based adhesive commercially available from ICI Paints of Strongsville, Ohio, U.S.A. Alternatively, the adhesive composition may be a silicone composition. The silicone composition may be a seam sealant composition, a hot melt composition, a high consistency rubber (HCR) composition, a liquid silicone rubber composition or a combination thereof.

The adhesive composition may be a 1-part curable composition or a multiple part composition. The adhesive composition may be a hydrosilylation curable polyorganosiloxane composition, a peroxide curable polyorganosiloxane composition, or an organo-borane curable polyorganosiloxane composition. Alternatively, the adhesive composition may be a condensation reaction curable composition.

### Seam Sealant Composition

The curable sealant composition used in the process described above may be a hydrosilylation reaction curable polyorganosiloxane composition. Examples of such compositions are known in the art. For example, U.S. Pat. No. 6,811,650, which is hereby incorporated by reference, discloses a composition suitable for use as the curable sealant composition in the process described above. Alternatively, commercially available seam sealants may be used, and examples include DOW CORNING® SE 6711, SE 6750, and SE 6777, which are commercially available from Dow Corning Corporation of Midland, Mich., U.S.A.

Alternatively, the curable sealant composition may be a curable polyorganosiloxane composition which is flowable or pumpable at 25° C. and which cures to form an elastomer upon heating. An exemplary hydrosilylation reaction curable polyorganosiloxane composition comprises:
(A) a polyorganosiloxane having an average, per molecule, of at least two organic groups having terminal aliphatic unsaturation;
(B) a crosslinker having an average per molecule of at least two silicon-bonded hydrogen atoms;
optionally (C) a filler; and
(D) a hydrosilylation catalyst.

### Ingredient (A) Polyorganosiloxane with Aliphatic Unsaturation

Ingredient (A) is a polyorganosiloxane having an average, per molecule, of at least two organic groups having terminal aliphatic unsaturation. The aliphatically unsaturated organic groups in ingredient (A) may be alkenyl exemplified by, but not limited to, vinyl, allyl, butenyl, pentenyl, and hexenyl, alternatively vinyl. The aliphatically unsaturated organic groups may be alkynyl groups exemplified by, but not limited to, ethynyl, propynyl, and butynyl. The aliphatically unsaturated organic groups in ingredient (A) may be located at terminal, pendant, or both terminal and pendant positions. The remaining silicon-bonded organic groups in ingredient (A) may be other monovalent hydrocarbon groups, which may be substituted or unsubstituted. Monovalent unsubstituted hydrocarbon groups are exemplified by, but not limited to alkyl groups such as methyl, ethyl, propyl, pentyl, octyl, undecyl, and octadecyl; aromatic groups such as ethylbenzyl, naphthyl, phenyl, tolyl, xylyl, benzyl, styryl, 1-phenylethyl, and 2-phenylethyl, alternatively phenyl; and cycloalkyl groups such as cyclohexyl. Monovalent substituted hydrocarbon groups are exemplified by, but not limited to halogenated alkyl groups such as chloromethyl, 3-chloropropyl, and 3,3,3-trifluoropropyl, fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl.

Ingredient (A) may have unit formula (I): (R¹SiO_{3/2})ₐ(R¹₂SiO_{2/2})_{b}(R¹₃SiO_{1/2})_{c}(SiO_{4/2})_{d}(XO_{1/2})ₑ. In this formula, each R¹ is independently an aliphatically unsaturated organic group or a monovalent hydrocarbon group as described above, with the proviso that on average at least two R¹ per molecule are aliphatically unsaturated organic groups. X is a hydrogen atom or a monovalent hydrocarbon group, subscript a is 0 or a positive number, subscript b is a positive number, subscript c is 0 or a positive number, subscript d is 0 or a positive number, and subscript e is 0 or a positive number.

Ingredient (A) may comprise a polydiorganosiloxane of general formula (II): R¹₃SiO—(R¹₂SiO)_{f}—SiR¹₃, where R¹ is as described above, and subscript f is an integer having a value sufficient to provide ingredient (A) with a viscosity ranging from 100 to 1,000,000 mPa·s at 25° C. Alternatively, formula (II) is an α, ω-dialkenyl-functional polydiorganosiloxane such as dimethylvinylsiloxy-terminated polydimethylsiloxane.

Ingredient (A) is exemplified by dimethylvinylsiloxy-terminated polydimethylsiloxane, trimethylsiloxy-terminated, poly(dimethylsiloxane/methylvinylsiloxane), and polyorganosiloxanes comprising siloxane units of the formulae (CH₃)₃SiO_{1/2}, (CH₃)₂CH₂═CHSiO_{1/2}, and SiO_{4/2}. Ingredient (A) can be one polyorganosiloxane or a combination comprising two or more polyorganosiloxanes that differ in at least one of the following properties: structure, viscosity, average molecular weight, siloxane units, and sequence. The composition may contain 100 parts by weight of ingredient (A).

### Ingredient (B) Crosslinker

Ingredient (B) is a crosslinker having an average, per molecule, of more than two silicon bonded hydrogen atoms. Ingredient (B) may have unit formula (III): (R²SiO_{3/2})^{h}(R²₂SiO_{2/2})ᵢ(R²₃SiO_{1/2})ⱼ(SiO_{4/2})ₖ(XO)ₘ where each R² is independently a hydrogen atom or a monovalent substituted or unsubstituted hydrocarbon group as exemplified above, X is as described above, subscript h is a positive number, subscript i is a positive number, subscript j is 0 or a positive number, subscript k is 0 or a positive number, and subscript m is 0 or a positive number.

Ingredient (B) may comprise a polydiorganohydrogensiloxane of general formula (IV): HR³₂SiO—(R³₂SiO)_{g}—SiR³₂H, where each R³ is independently a hydrogen atom or a monovalent substituted or unsubstituted hydrocarbon group as exemplified above, and subscript g is an integer with a value of 1 or more. Alternatively, ingredient (B) may comprise hydrogen-terminated dimethylsiloxane, trimethylsiloxy-terminated poly(dimethyl/methylhydrogen siloxane), or a combination thereof.

Ingredient (B) can be one crosslinker or a combination comprising two or more crosslinkers that differ in at least one of the following properties: structure, viscosity, average molecular weight, siloxane units, and sequence. The amount of ingredient (B) may be selected such that the molar ratio of silicon bonded hydrogen atoms to aliphatically unsaturated organic groups ranges from 1:100 to 20:1 in this composition.

### Ingredient (C) Filler

Ingredient (C) is a filler. Ingredient (C) may comprise a reinforcing filler, an extending filler, or a combination thereof. The reinforcing filler may optionally be added in an amount ranging from 5 to 200 parts based on 100 parts of ingredient (A). Examples of suitable reinforcing fillers include reinforcing silica fillers such as fume silica, silica aerogel, silica zerogel, and precipitated silica. Fumed silicas are known in the art and commercially available; a fumed silica is sold under the name CAB-O-SIL by Cabot Corporation of Massachusetts, U.S.A.

The extending filler may optionally be added to the composition in an amount ranging from 5 to 200 parts based on 100 parts of ingredient (A). Examples of extending fillers include glass beads, kaolin, quartz, aluminum oxide, magnesium oxide, calcium carbonate, zinc oxide, talc, diatomaceous earth, iron oxide, clays, titanium dioxide, zirconia, sand, carbon black, graphite, or a combination thereof. Extending fillers are known in the art and commercially available; such as a ground silica sold under the name MIN-U-SIL by U.S. Silica of Berkeley Springs, W. Va., U.S.A.

### Ingredient (D) Hydrosilylation Catalyst

Ingredient (D) is a hydrosilylation catalyst. Ingredient (D) is added in an amount sufficient to promote curing of the composition. The exact amount depends on the specific catalyst selected; however, ingredient (D) may be added in an amount sufficient to provide 0.01 to 500 ppm of platinum group metal, based on 100 parts of ingredient (A).

Suitable hydrosilylation catalysts are known in the art and commercially available. Ingredient (D) may comprise a platinum group metal selected from the group consisting of platinum, rhodium, ruthenium, palladium, osmium or iridium metal or organometallic compound thereof, and a combination thereof. Ingredient (D) is exemplified by platinum black, compounds such as chloroplatinic acid, chloroplatinic acid hexahydrate, a reaction product of chloroplatinic acid and a monohydric alcohol, platinum bis-(ethylacetoacetate), platinum bis-(acetylacetonate), platinum dichloride, and complexes of said compounds with olefins or low molecular weight polyorganosiloxanes or platinum compounds microencapsulated in a matrix or coreshell type structure. Complexes of platinum with low molecular weight polyorganosiloxanes include 1,3-diethenyl-1,1,3,3-tetramethyldisiloxane complexes with platinum. These complexes may be microencapsulated in a resin matrix. Alternatively, the catalyst may comprise 1,3-diethenyl-1,1,3,3-tetramethyldisiloxane complex with platinum. When the catalyst is a platinum complex with a low molecular weight polyorganosiloxane, the amount of catalyst may range from 0.02 to 0.2 parts based on the weight of the composition.

Suitable hydrosilylation catalysts for ingredient (D) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B. Microencapsulated hydrosilylation catalysts and methods of preparing them are also known in the art, as exemplified in U.S. Pat. No. 4,766,176; and U.S. Pat. No. 5,017,654.

The hydrosilylation curable polyorganosiloxane composition described above may further comprise an additional ingredient selected from the group consisting of (E) a filler treating agent, (F) an adhesion promoter, (G) a pigment, (H) a cure modifier, (J) a nonreactive resin, (I) a stabilizer, and a combination thereof, provided however that any additional ingredients and amounts added do not render the composition incapable of curing to form an elastomer suitable for use in an airbag.

### Ingredient (E) Filler Treating Agent

The composition may optionally further comprise ingredient (E), a filler treating agent in an amount ranging from 0 to 1 part based on 100 parts of ingredient (A). Ingredient (C) may optionally be surface treated with ingredient (E). Ingredient (C) may be treated with ingredient (E) before being added to the composition, or in situ. Ingredient (E) may comprise a silane such as an alkoxysilane, an alkoxy-functional oligosiloxane, a cyclic polyorganosiloxane, a hydroxyl-functional oligosiloxane such as a dimethyl siloxane or methyl phenyl siloxane, a stearate, or a fatty acid. Examples of silanes include hexamethyldisilazane. Examples of stearates include calcium stearate. Examples of fatty acids include stearic acid, oleic acid, palmitic acid, tallow, coco, and combinations thereof. Examples of filler treating agents and methods for their use are disclosed in, for example, EP 1 101 167 A2 and U.S. Pat. Nos. 5,051,455, 5,053,442, and 6,169,142 (col. 4, line 42 to col. 5, line 2).

### Ingredient (F) Adhesion Promoter

Ingredient (F) is an adhesion promoter, as described below for ingredient (V). Ingredient (F) may be added in an amount ranging from 0.01 to 10 parts based on 100 parts of ingredient (A).

### Ingredient (G) Pigment

Ingredient (G) is a pigment. Examples of suitable pigments include iron (III) oxide, titanium dioxide, or a combination thereof. Ingredient (G) may be added in an amount ranging from 0 to 0.5 parts based on the 100 parts of ingredient (A).

### Ingredient (H) Cure Modifier

Ingredient (H) is a cure modifier. Ingredient (H) can be added to extend the shelf life or working time, or both, of the hydrosilylation curable polyorganosiloxane composition. Ingredient (H) can be added to raise the curing temperature of the composition. Ingredient (H) may be added in an amount ranging from 0.01 to 5 parts based on 100 parts of ingredient (A).

Suitable cure modifiers are known in the art and are commercially available. Ingredient (H) is exemplified by acetylenic alcohols, alkyl alcohols, cycloalkenylsiloxanes, ene-yne compounds, triazoles, phosphines, mercaptans, hydrazines, amines, fumarates, maleates, and combinations thereof.

Examples of acetylenic alcohols are disclosed, for example, in EP 0 764 703 A2 and U.S. Pat. No. 5,449,802 and include methyl butynol, ethynyl cyclohexanol, dimethyl hexynol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, 3,5-dimethyl-1-hexyn-3-ol, and 1-ethynyl-1-cyclohexanol, and combinations thereof.

Examples of alkyl alcohols include ethanol, isopropanol, or combinations thereof.

Examples of cycloalkenylsiloxanes include methylvinylcyclosiloxanes exemplified by 1,3,5,7-tetramethyl-1,3,5,7-tetravinylcyclotetrasiloxane, 1,3,5,7-tetramethyl-1,3,5,7-tetrahexenylcyclotetrasiloxane, and combinations thereof. Examples of ene-yne compounds include 3-methyl-3-penten-1-yne, 3,5-dimethyl-3-hexen-1-yne, and combinations thereof. Examples of triazoles include benzotriazole. Examples of phosphines include triphenylphosphine. Examples of amines include tetramethyl ethylenediamine. Examples of fumarates include dialkyl fumarates, dialkenyl fumarates, dialkoxyalkyl fumarates, and combinations thereof. Suitable cure modifiers are disclosed by, for example, U.S. Pat. Nos. 3,445,420; 3,989,667; 4,584,361; and 5,036,117.

Alternatively, ingredient (H) may comprise a silylated acetylenic inhibitor. A silylated acetylenic inhibitor is a reaction product of a silane and an acetylenic alcohol, described above. Examples of silylated acetylenic inhibitors and methods for their preparation are disclosed, for example, in EP 0 764 703 A2 and U.S. Pat. No. 5,449,802.

### Ingredient (J) Nonreactive Resin

Ingredient (J) is a resin that may be added in addition to or instead of the filler. Nonreactive means that the resin does not participate in the curing reaction with ingredients (A) or (B). The nonreactive resin may be a polyorganosiloxane comprising siloxane units of the formulae (CH₃)₃SiO_{1/2} and SiO_{4/2} (MQ resin). Ingredient (J) may be added in an amount ranging from 0 to 30 based on 100 parts of ingredient (A).

The curable sealant composition may be prepared as a one-part composition or as a multiple part composition. In a multiple part composition, such as a two-part composition, ingredients (B) and (D) are stored in separate parts, which are combined shortly before step ii) in the process described above.

### Hot Melt Curable Adhesive

Commercially available hot melt adhesives may be used in the process described above. Examples of suitable hot melt compositions used to prepare the hot melt adhesives include moisture curable hot melt compositions and polyurethane hot melt compositions, which are commercially available from National Starch of New Jersey, U.S.A. Examples of suitable hot melt compositions used to prepare hot melt adhesives include DOW CORNING® HM 2500 and HM 2510, which are commercially available from Dow Corning Corporation of Midland, Mich., U.S.A. The hot melt composition suitable for use in the process may not be flowable at 25° C. but may be flowable at temperatures ranging from 50° C. to 150° C., alternatively 70° C. to 130° C. The hot melt composition may be noncurable, e.g., the hot melt composition is fluid when heated and forms a hot melt adhesive upon cooling without needing a curing reaction to form the hot melt adhesive. Examples of noncurable hot melt compositions and methods for their preparation are disclosed, for example, in U.S. Pat. Nos. 5,352,722; 5,578,319; 5,482,988; 5,328,696; and 5,371,128. Alternatively, the hot melt composition may be a hydrosilylation reaction curable composition, a condensation reaction curable composition, or a combination thereof. Examples of hydrosilylation curable hot melt compositions are disclosed, for example, in U.S. Pat. Nos. 5,248,739 and 6,121,368, and EP 1035161A2. Examples of condensation reaction curable hot melt compositions and methods for their preparation are disclosed, for example, in WO 2004/037941.

The hot melt composition may be a condensation reaction curable polyorganosiloxane composition which is not flowable at 25° C. but is flowable at temperatures ranging from 50° C. to 150° C., alternatively 70° C. to 130° C. An exemplary condensation reaction curable polyorganosiloxane composition comprises:

(I) a polyorganosiloxane resin,
(II) a polyorganosiloxane having an average, per molecule, of at least two silicon bonded hydrolyzable groups, and
(III) a silane crosslinker.

### Ingredient (I) Polyorganosiloxane Resin

A polyorganosiloxane resin useful herein has unit formula (V): (R⁴SiO_{3/2})ₙ(R⁴₂SiO_{2/2})ₒ(R⁴₃SiO_{1/2})ₚ(SiO_{4/2})_{q}(X′)ᵣ.

Each R⁴ represents a substituted or unsubstituted monovalent hydrocarbon group as exemplified above, and X′ is hydrolyzable group or an organic group having terminal aliphatic unsaturation, such as an alkenyl group. Suitable hydrolyzable groups for X′ include a hydroxyl group; an alkoxy group such as methoxy and ethoxy; an alkenyloxy group such as isopropenyloxy; a ketoximo group such as methyethylketoximo; a carboxy group such as acetoxy; an amidoxy group such as acetamidoxy; and an aminoxy group such as N,N-dimethylaminoxy. Subscript n is 0 or a positive number, subscript o is 0 or a positive number, subscript p is 0 or a positive number, subscript q is 0 or a positive number, and subscript r is 0 or greater, alternatively r is at least 2. The quantity (p+q) is 1 or greater, and the quantity (n+o) is 1 or greater.

The polyorganosiloxane resin is soluble in liquid organic solvents such as liquid hydrocarbons exemplified by benzene, toluene, xylene, heptane and in liquid organosilicon compounds such as a low viscosity cyclic and linear polydiorganosiloxanes. The polyorganosiloxane resin may comprise amounts R⁴₃SiO_{1/2} and SiO_{4/2} units in a molar ratio ranging from 0.5/1 to 1.5/1, alternatively from 0.6/1 to 0.9/1. These molar ratios are conveniently measured by Si²⁹ nuclear magnetic resonance (n.m.r.) spectroscopy.

The number average molecular weight, Mₙ, to achieve desired flow characteristics of the polyorganosiloxane resin will depend at least in part on the molecular weight of the polyorganosiloxane resin and the type(s) of hydrocarbon group, represented by R⁴, that are present in this ingredient. Mₙ as used herein represents the molecular weight measured using gel permeation chromatography, when the peak representing the neopentamer is excluded form the measurement. The Mₙ of the polyorganosiloxane resin is may be greater than 3,000, alternatively Mₙ may range from 4500 to 7500.

The polyorganosiloxane resin can be prepared by any suitable method. Such resins may be prepared by cohydrolysis of the corresponding silanes or by silica hydrosol capping methods known in the art. For example, the silica hydrosol capping processes of Daudt, et al., U.S. Pat. No. 2,676,182; of Rivers-Farrell et al., U.S. Pat. No. 4,611,042; and of Butler, U.S. Pat. No. 4,774,310 may be used.

The intermediates used to prepare the resin may be triorganosilanes of the formula R⁴₃SiX″, where X″ represents a hydrolyzable group, and either a silane with four hydrolyzable groups such as halogen, alkoxy or hydroxyl, or an alkali metal silicate such as sodium silicate.

It may be desirable that the silicon-bonded hydroxyl groups (e.g., HOR⁴₂SiO_{1/2} or HOSiO_{3/2} groups) in the polyorganosiloxane resin be below 0.7% of the weight of the resin, alternatively below 0.3%. Silicon-bonded hydroxyl groups formed during preparation of the resin may be converted to trihydrocarbylsiloxy groups or a hydrolyzable group by reacting the resin with a silane, disiloxane or disilazane containing the appropriate terminal group. Silanes containing hydrolyzable groups are typically added in excess of the quantity required to react with the silicon-bonded hydroxyl groups of the resin.

Ingredient (I) can be one polyorganosiloxane resin or a combination comprising two or more polyorganosiloxane resins that differ in at least one of the following properties: structure, viscosity, average molecular weight, siloxane units, and sequence. The amount of ingredient (I) added may range from 55 to 75 parts based on the weight of the composition.

### Ingredient (II) Hydrolyzable Polyorganosiloxane

The polyorganosiloxane useful herein is comprised of difunctional units of the formula R⁵R⁶SiO and terminal or branching units of the formula R⁷ₛX³₃₋ₛSiG- wherein R⁵ is an alkoxy group or a monovalent unsubstituted or substituted hydrocarbon group, such as an alkyl group or an alkenyl group; R⁶ is a unsubstituted or substituted monovalent hydrocarbon group; R⁷ is aminoalkyl or R⁴ group X³ is a hydrolyzable group; G is a divalent group linking the silicon atom of the terminal unit with another silicon atom and subscript s is 0 or 1. The polyorganosiloxane can optionally contain up to about 20 percent, based on total of trifunctional units of the formula R⁶SiO_{3/2} where R⁶ is as described previously. At least 50 percent, alternatively at least 80 percent, of the radicals represented by R⁵ and R⁶ in the R⁵R⁶SiO units may be alkyl groups of 1 to 6 carbon atoms, such as methyl.

The terminal units present on the polyorganosiloxane are represented by the formula R⁷ₛX³₃₋ₛSiG-, where X³, R⁷, G, and subscript s are as described above. Examples of hydrolyzable groups represented by X³ include but are not limited to hydroxy, alkoxy such as methoxy and ethoxy, alkenyloxy such as isopropenyloxy, ketoximo such as methyethylketoximo, carboxy such as acetoxy, amidoxy such as acetamidoxy and aminoxy such as N,N-dimethylaminoxy.

In the terminal groups when s is 0 the groups represented by X³ can be alkoxy, ketoximo, alkenyloxy, carboxy, aminoxy or amidoxy. When s is 1, X³ can be alkoxy and R⁷ can be alkyl such as methyl or ethyl, or aminoalkyl such as aminopropyl or 3-(2-aminoethylamino)propyl. The amino portion of the aminoalkyl radical can be primary, secondary or tertiary.

In the formula for the terminal unit G is a divalent group or atom that is hydrolytically stable. By hydrolytically stable it is meant that it is not hydrolyzable and links the silicon atom(s) of the terminal unit to another silicon atom in the polyorganosiloxane such that the terminal unit is not removed during curing of the composition and the curing reaction is not adversely affected. Hydrolytically stable linkages represented by G include but are not limited to an oxygen atom, a hydrocarbylene group such as alkylene and phenylene, a hydrocarbylene containing one or more hetero atoms selected from oxygen, nitrogen and sulfur, and combinations of these linking groups. G can represent a silalkylene linkage such as —(OSiMe₂)CH₂CH₂—, —(CH₂CH₂SiMe₂)(OSiMe₂)CH₂CH₂—, —(CH₂CH₂SiMe₂)O—, (CH₂CH₂SiMe₂)OSiMe₂)O—, —(CH₂CH₂SiMe₂)CH₂CH₂— and —CH₂CH₂—, a siloxane linkage such as —(OSiMe₂)O—.

Specific examples of preferred terminal units include, but are not limited to, (MeO)₃SiCH₂CH₂—, (MeO)₃SiO—, Me(MeO)₂SiO—, H₂NCH₂CH₂N(H)(CH₂)₃SiO—, (EtO)₃SiO—, (MeO)₃SiCH₂CH₂Si(Me₂)OSi(Me₂)CH₂CH₂—, (MeO)₃SiCH₂CH₂Si(Me₂)OSi(Me₂)CHCH₃—, Me₂NOSiO—, MeC(O)N(H)SiO— and CH₂═C(CH₃)OSiO—. Me in these formulae represents methyl, and Et represents ethyl.

When X³ contains an alkoxy group, it may be desirable to separate this X³ group from the closest siloxane unit by an alkylene radical such as ethylene. In this instance, R⁷ₛX³₃₋ₛSiG- could be (MeO)₃SiCH₂CH₂Si(Me₂)O—. Methods for converting hydroxyl groups to trialkoxysilylalkyl groups are known in the art. For example, moisture reactive groups having the formulae (MeO)₃SiO— and Me(MeO)₂SiO— can be introduced into a silanol-terminated polyorganosiloxane by compounds having the formulae (MeO)₄Si and Me(MeO)₃Si, respectively. Alternatively, compounds having the formulae (MeO)₃SiH and Me(MeO)₂SiH, respectively, can be used when the polyorganosiloxane contains silanol groups or aliphatically unsaturated organic groups such alkenyl groups, e.g., vinyl and a hydrosilylation reaction catalyst such as those described above for ingredient (D). It will be understood that other hydrolyzable groups such as dialkylketoximo, alkenyloxy and carboxy can replace the alkoxy group.

The viscosity of the polyorganosiloxane may range from 0.02 Pa·s to 100 Pa·s at 25° C., alternatively 0.35 Pa·s to 60 Pa·s. Ingredient (II) can be one polyorganosiloxane or a combination comprising two or more polyorganosiloxanes that differ in at least one of the following properties: structure, viscosity, average molecular weight, siloxane units, and sequence. The amount of ingredient (II) added may range from 25 to 45 parts based on the weight of the composition.

Ingredients (I) and (II) are present in amounts sufficient to provide 55% to 75% resin solids based on the combined amounts of ingredients (I) and (II). Higher amounts of resin can be used however; higher application temperatures may be needed to apply the moisture curable hot melt composition to a substrate.

### Ingredient (III) Silane Crosslinker

The silane crosslinker is represented by the formula R⁴ₜSiZ₍₄₋ₜ₎, where R⁴ is as described previously and Z is a hydrolyzable group that reacts with the terminal groups of at least the polyorganosiloxane under ambient conditions to form a cured material and t is 0, 1 or 2. Suitable hydrolyzable groups represented by Z include but are not limited to alkoxy containing from 1 to 4 carbon atoms, carboxy such as acetoxy, ketoximo such as methylethylketoximo and aminoxy. When t is 2 in the silane crosslinker, the polyorganosiloxane may contain three X³ groups (e.g., s is 0).

Suitable silane crosslinkers include but are not limited to methyltrimethoxysilane, isobutyltrimethoxysilane, methyltris(methylethylketoximo)silane, methyltriethoxysilane, isobutyltriethoxysilane, methyltriacetoxysilane and alkyl orthosilicates such as ethyl orthosilicate.

The amount of silane crosslinker used may range from 0 to 15 parts per hundred (pph), alternatively 0.5 to 15 pph based on the amount of ingredients (I) and (II). Without wishing to be bound by theory, it is thought that if too much silane crosslinker is present, the green strength and/or cure rate of the hot melt composition will decrease. If the silane crosslinker is volatile it may be necessary to use an excess amount during processing to achieve the 0.5 to 15 pph in the final hot melt composition. One skilled in the art will be able to determine the amount need to produce a hot melt composition with 1.5 to 15 pph.

### Optional Ingredients

The condensation reaction curable hot melt composition may optionally further comprise one or more additional ingredients. The additional ingredients are exemplified by (IV) a condensation reaction catalyst, (V) an adhesion promoter, (VI) a filler, (VII) a solvent, (VIII) a bodied resin, (IX) a polyorganosiloxane wax, (X) an organic resin, (XI) a heat stabilizer, or a combination thereof.

### Ingredient (IV) Condensation Reaction Catalyst

A condensation reaction catalyst may be added to the hot melt composition. Ingredient (IV) may comprise a carboxylic acid salt of metal, a tin compound, a titanium compound, or a zirconium compound. Ingredient (IV) may comprise carboxylic acid salts of metals, ranging from lead to manganese inclusive, in the electromotive series of metals. Alternatively, ingredient (IV) may comprise a chelated titanium compound, a titanate such as a tetraalkoxytitanate, an organotitanium compound such as isopropyltitanate, tetra tert butyl titanate and partially chelated derivatives thereof with chelating agents such as acetoacetic acid esters and beta-diketones or a combination thereof. Examples of suitable titanium compounds include, but are not limited to, diisopropoxytitanium bis(ethylacetoacetate), tetrabutoxy titanate, tetrabutyltitanate, tetraisopropyltitanate, and bis-(ethoxyacetoacetonate)diisopropoxy titanium (IV), and a combination thereof. Alternatively ingredient (IV) may comprise a tin compound such as dibutyltin diacetate, dibutyltin dilaurate, dibutyl tin oxide, stannous octoate tin oxide, or a combination thereof. Examples of catalysts are disclosed in U.S. Pat. Nos. 4,962,076; 5,051,455; and 5,053,442. The amount of catalyst may range from 0.01 to 2 pph based on the amount of ingredients (I) and (II). Without wishing to be bound by theory, it is thought that if too much catalyst is added, then the cure of the hot melt composition will be impaired. Additionally, as the amount of catalyst is increased the viscosity of the hot melt composition may increase, resulting in higher melt temperature required to apply the hot melt composition.

### Ingredient (V) Adhesion Promoter

The hot melt composition may optionally further comprise an adhesion promoter in an amount ranging from 0.05 to 2 pph based on the combined weights of ingredients (I) and (II). Adhesion promoters are known in the art, and may comprise an alkoxysilane, a combination of an alkoxysilane with a transition metal chelate, a combination of an alkoxysilane with a hydroxy-functional polyorganosiloxane, or a partial hydrolyzate of an alkoxysilane. Suitable alkoxysilanes may have the formula R⁸ᵤR⁹ᵥSi(OR¹⁰)₄₋₍ᵤ₊ᵥ₎ where each R⁸ and each R¹⁰ are independently substituted or unsubstituted, monovalent hydrocarbon groups having at least 3 carbon atoms, and R⁹ contains at least one SiC bonded organic group having an adhesion-promoting group, such as alkenyl, amino, epoxy, mercapto or acrylate groups, subscript u has the value of 0 to 2, subscript v is either 1 or 2, and the quantity (u+v) is not greater than 3. The adhesion promoter can also be a partial condensate of the above silane.

Examples of suitable adhesion promoters are exemplified by (epoxycyclohexyl)ethyldimethoxysilane, (epoxycyclohexyl)ethyldiethoxysilane, allyltrimethoxysilane, allyltriethoxysilane, aminopropyltrimethoxysilane, aminopropyltriethoxysilane, (ethylenediaminepropyl)trimethoxysilane glycidoxypropyltrimethoxysilane, glycidoxypropyltriethoxysilane, hexenyltrimethoxysilane, 3-mercaptoproyltrimethoxysilane, methacryloyloxypropyl trimethoxysilane, 3-methacryloyloxypropyl triethoxysilane, 3-acryloyloxypropyl trimethoxysilane, 3-acryloyloxypropyl triethoxysilane, undecylenyltrimethoxysilane, vinyltrimethoxysilane, vinyltriethoxysilane, tetrapropylorthosilicate, tetrabutylorthosilicate, tetrakis(2-butoxyethyl)orthosilicate, and combinations thereof. Alternatively, the adhesion promoter may comprise a reaction product of a hydroxy-terminated polyorganosiloxane with an epoxy-functional alkoxysilane, as described above, or a physical blend of the hydroxy-terminated polyorganosiloxane with the epoxy-functional alkoxysilane such as a combination of an epoxy-functional alkoxysilane and an epoxy-functional siloxane. For example, the adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methyvinyl/dimethylsiloxane copolymer. When used as a physical blend rather than as a reaction product, these components may be stored separately in multiple-part kits.

Suitable transition metal chelates include titanates such as tetrabutoxytitanate, zirconates such as zirconium acetylacetonate or zirconium tetrakisacetylacetonate, aluminum chelates such as aluminum acetylacetonate, and a combination thereof. Transition metal chelates and methods for their preparation are known in the art, see for example, U.S. Pat. No. 5,248,715, EP 0 493 791 A1, and EP 0 497 349 B1. One skilled in the art would recognize that some or all of the transition metal chelates can be condensation reaction catalysts and that the transition metal chelate that may be added as an adhesion promoter is added in addition to any condensation reaction catalyst.

### Ingredient (VI) Filler

The hot melt composition may optionally further comprise 0.1 to 40 parts of filler based the weight of the composition. Examples of suitable fillers include calcium carbonates, fumed silica, kaolin, silicate, metal oxides, metal hydroxides, carbon blacks, sulfates or zirconates. The filler may be the same as or different from the filler described above as ingredient (C). The filler may optionally be treated with a filler treating agent described above as ingredient (E). To improve stress-strain behavior and reduce creep, filler may be added to the hot melt composition in an amount ranging from 3% to 15%, alternatively 5% to 10%, based on the weight of the composition. The exact amount of filler to improve stress-strain behavior will vary depending on the type of filler selected and its particle size, for example 1% to 5% silica may be added or 6% to 10% calcium carbonate may be added.

### Ingredient (VII) Solvent

Solvent may be used in producing the hot melt composition. Solvent aids with the flow and introduction of ingredients (I) and (II). However, essentially all of the solvent is removed in the continuous process for producing the hot melt adhesive. By essentially all of the solvent is removed, it is meant that the hot melt composition may contain no more than 0.05% to 5%, alternatively than 0.5% solvent based on the weight of the hot melt composition. If too much solvent is present the viscosity of the hot melt adhesive will be too low and the product performance will be hindered.

Solvents used herein are those that help fluidize the ingredients used in producing the hot melt composition but essentially do not react with any of the components in the hot melt adhesive. Suitable solvents are organic solvents such as toluene, xylene, methylene chloride, naphtha mineral spirit and low molecular weight siloxanes, such as phenyl containing polyorganosiloxanes.

### Ingredient (VIII) Bodied Resin

Ingredient (VIII) may be a bodied MQ resin comprising a resinous core and a nonresinous polyorganosiloxane group. Ingredient (VIII) may be prepared by methods known in the art.

An MQ resin comprises siloxane units of the formulae R¹¹₃SiO_{1/2} and SiO_{4/2}, where each R¹¹ is independently a monovalent hydrocarbon group, a monovalent halogenated hydrocarbon group, a hydrogen atom, or a hydroxyl group. Examples of monovalent hydrocarbon groups for R¹¹ include, but are not limited to, alkyl such as methyl, ethyl, propyl, pentyl, octyl, undecyl, and octadecyl; cycloalkyl such as cyclohexyl; aryl such as phenyl, tolyl, xylyl, benzyl, and 2-phenylethyl. Examples of monovalent halogenated hydrocarbon groups for R¹¹ include, but are not limited to, chlorinated alkyl groups such as chloromethyl and chloropropyl groups and fluorinated alkyl groups such as 3,3,3-trifluoropropyl, 4,4,4,3,3-pentafluorobutyl, 5,5,5,4,4,3,3-heptafluoropentyl, and 6,6,6,5,5,4,4,3,3-nonafluorohexyl.

The MQ resin may have a ratio of M units to Q units (M:Q) of 0.5 to 1.2, alternatively 0.89:1 to 1:1. The MQ resin may have a number average molecular weight of 1,500 to 8,000, alternatively 5,000. The MQ resin may have a weight average molecular weight of 3,000 to 40,000, alternatively 15,000.

Methods of preparing MQ resins are known in the art. For example, a MQ resin may be prepared by treating a product produced by the silica hydrosol capping process of Daudt, et al. disclosed in U.S. Pat. No. 2,676,182. Briefly stated, the method of Daudt, et al. involves reacting a silica hydrosol under acidic conditions with a hydrolyzable triorganosilane such as trimethylchlorosilane, a siloxane such as hexamethyldisiloxane, or combinations thereof, and recovering a product comprising M and Q units (MQ resin). The resulting MQ resins may contain from 2 to 5 percent by weight of silicon-bonded hydroxyl groups.

A bodied MQ resin may be prepared from the MQ resin described above by methods known in the art, such as those disclosed in U.S. Pat. Nos. 5,726,256; 5,861,472; and 5,869,556. For example, the bodied MQ resin may be prepared by dissolving the MQ resin described above in a solvent, such as a solvent described herein as ingredient (VII); heating the MQ resin in the presence of an acid or base catalyst and a polydiorganosiloxane terminated with silicon-bonded hydroxyl groups; and removing water. The resulting product of this process is a bodied MQ resin comprising (i) a core and (ii) a polydiorganosiloxane group, where the polydiorganosiloxane group has a terminal silicon-bonded hydroxyl group. The bodied MQ resin may contain 0.5% to 2%, alternatively 0.75% to 1.25% hydroxyl groups.

The bodied MQ resin described above may optionally treated by dissolving the bodied MQ resin, a treating agent, and an acid catalyst or base catalyst in a solvent and heating the resulting combination until the hydroxyl content of the MQ resin is 0 to 2%, alternatively 0.5% to 1%. The treating agent may be a silane of the formula R¹²₃SiR¹³, where each R¹² is independently a monovalent hydrocarbon group such as methyl, vinyl, or phenyl, alternatively methyl; and R¹³ is a group reactive with silanol. The acid catalyst may be trifluoroacetic acid. The base catalyst may be ammonia. The solvent may be a solvent described herein as ingredient (VII), such as xylene. The treating process reacts the R¹³ substituted silicon atom a hydroxyl group in the MQ resin, thereby linking the R¹²₃Si— group with a silicon atom in the MQ resin through a divalent oxygen atom.

Ingredient (VIII) can be a single bodied MQ resin or a combination comprising two or more bodied MQ resins that differ in at least one of the following properties: hydroxyl group content, ratio of amount of component (i) to component (ii), siloxane units, and sequence. The ratio of the amount of component (i) to amount of component (ii) may range from 1 to 2.5. The amount of ingredient (VIII) added to the composition depends on various factors including resin/polymer ratio, however, ingredient (VIII) may be added in an amount ranging from 30 to 70 parts based on the weight of the composition.

### Ingredient (IX) Polyorganosiloxane Wax

Ingredient (IX) is a polyorganosiloxane wax, such as an alkylmethylsiloxane wax. Polyorganosiloxane wax may be added to the composition to improve green strength. Polyorganosiloxane waxes are disclosed in U.S. Pat. Nos. 7,074,490 and 5,380,527. The amount of ingredient (IX) may range from 0 to 5 parts per hundred parts of the hot melt composition.

The hot melt composition may be prepared by methods known in the art, for example, a suitable method comprises combining ingredients (I), (II), (II), (VII), and any additional ingredients, if present; feeding the combination through an extrusion device to remove volatiles; and recovering a hot melt composition having a non-volatile content of 95% or more.

### HCR Composition

Alternatively, an HCR composition may be used instead of a seam sealant composition or a hot melt composition in the process described above. Commercially HCR compositions may be used, and examples include DOW CORNING® 20798, 20799, and 20800, and custom variations (e.g., different colored compositions), which are commercially available from Dow Corning Corporation of Midland, Mich., U.S.A.

### Airbag Component

The airbag components may be panels or patches, such as heat shield patches or reinforcing patches. Examples of suitable airbag components may be fabricated from woven or nonwoven fabrics, for example a nonwoven urethane or a woven synthetic resin such as Nylon. A suitable airbag component has a surface optionally coated with a commercially available airbag coating, such as a liquid silicone rubber. For example, DOW CORNING® LCF 3600 and LCF 4300 are liquid silicone rubbers commercially available from Dow Corning Corporation of Midland, Mich., U.S.A. See EP 1 179 454 p. 5, paragraph [0051] for exemplary airbag component materials of construction. One skilled in the art would recognize that in the processes described herein, the first textile and the second textile may be different airbag components, e.g., the first textile could be a panel and the second textile could be a patch or vice versa. Alternatively, the first textile could be one end of a piece of fabric and the second textile could be an opposite end of the piece of fabric, where the fabric is folded to bring the two ends in contact with one another through the nonsewn seam. Alternatively, the first textile could be a first fabric panel, and the second textile could be a second fabric panel, which are not connected to one another until brought together through the nonsewn seam.

### EXAMPLES

These examples are included to demonstrate the invention to those of ordinary skill in the art. However, those of skill in the art should, in light of the present disclosure, appreciate that many changes can be made in the specific embodiments which are disclosed and still obtain a like or similar result without departing from the spirit and scope of the invention set forth in the claims. The following ingredients were used in these examples.

Vinyl Functional Polyorganosiloxane Gum 1 was dimethylvinylsiloxy-terminated, poly(dimethyl/methylvinyl)siloxane having 0.725% vinyl and number average molecular weight (Mn) of 700,000.

Vinyl Functional Polyorganosiloxane Gum 2 was dimethylvinylsiloxy-terminated, polydimethylsiloxane having 0.12% vinyl and Mn=702,000.

Vinyl Functional Polyorganosiloxane Gum 3 was dimethylvinylsiloxy-terminated, poly(dimethyl/methylvinyl)siloxane having 0.065% vinyl and Mn=702,000.

Filler Treatment 1 was a hydroxy-terminated, polymethylvinylsiloxane having 3% hydroxyl groups, 29% vinyl groups and viscosity of 32 cst.

Filler Treatment 2 was a hydroxy-terminated, poly(dimethyl/methylvinyl)siloxane having 8% hydroxyl groups, 11% vinyl groups, and viscosity of 20 cst.

Filler Treatment 3 was tetramethyldivinylsilazane.

Filler Treatment 4 was hydroxy-terminated, polydimethylsiloxane having 3% hydroxyl groups, and viscosity of 41 cst.

Filler Treatment 5 was hydroxy-terminated, poly(dimethyl/methylvinyl)siloxane having 10% hydroxyl groups, 10% vinyl groups, and viscosity of 40 cst.

Filler Treatment 6 was hydroxy-terminated, polydimethylsiloxane having 3% hydroxyl groups, and viscosity of 42 cst.

Filler 1 is fumed silica with a typical surface area of 400 m²/gram BET.

Filler 2 is fumed silica with a typical surface area of 250 m²/gram BET.

Filler 3 is ground quartz having an average particle size of 5 micrometers.

Fluid 1 was dimethylvinylsiloxy-terminated, poly(dimethyl/methylvinyl)siloxane having 1% vinyl groups and viscosity of 350 cps.

Fluid 2 was dimethylvinylsiloxy-terminated, polydimethylsiloxane having 0.09% vinyl groups and viscosity of 50,000 cps.

Fluid 3 was trimethylsiloxy-terminated polydimethylsiloxane with a viscosity of 500 cst.

Crosslinker 1 was poly(dimethyl/methylhydrogen)siloxane with methyl silsesquioxane having 0.79% hydrogen and viscosity of 15 cst.

Crosslinker 2 was trimethylsiloxy-terminated, poly(dimethyl/methylhydrogen)siloxane having 0.76 hydrogen and viscosity of 5 cst.

Chain Extender 1 was hydrogen terminated polydimethylsiloxane having 0.15% hydrogen and viscosity of 11 cst.

Inhibitor 1 was methylvinyl cyclosiloxanes.

Inhibitor 2 was 1-ethynyl-1-cyclohexanol.

Catalyst 1 was 1,3-diethenyl-1,1,3,3-tetramethyldisiloxane complexes with platinum.

Catalyst 2 was 1% platinum complex in 98% Bisphenol A-carbonyl dichloride copolymer as encapsulant.

Stabilizer 1 was manganese carboxylate.

Adhesion Promoter 1 was 3-methacryloxypropyltrimethoxysilane.

Adhesion Promoter 2 was tris(2-methoxyethoxy)-vinylsilane.

Pigment 1 was iron oxide dispersed in a dimethylvinylsiloxy-terminated polydimethylsiloxane.

Pigment 2 was a blue pigment dispersed in Gum 3.

Peroxide 1 was 2,5-dimethyl-2,5-di(t-butylperoxy)hexane, commercially available from Akzo Nobel.

### Reference Examples 1-3

### Preparation of Silicone Adhesive Compositions

Silicone adhesive compositions were prepared by combining the ingredients in the amounts in Table 1. The ingredients combined in a high shear mixer by adding in the following order.
1) The polyorganosiloxane gums were added to a high shear mixer.
2) Water and filler treatments were then added to the mixer.
3) Filler was added to the mixer and massed to treat the filler in situ.
4) Heat and vacuum were applied to the mixer to remove excess water and reaction by-products.
5) Filler was added and mixed until massed while cooling to ambient temperature.
6) Polyorganosiloxane fluids were added to the mixer.
7) SiH functional crosslinkers and any optional chain extenders were added to the mixer.
8) Inhibitors were added to the mixer.
9) Catalyst was added to the mixer.
10) Heat Stabilizer was added to the mixer.
11) Adhesion promoters were added to the mixer under an inert gas blanket.
12) Pigment was added to the mixer.

TABLE 1
Silicone Adhesive Compositions

| Composition | 1 | 2 | 3 |
|---|---|---|---|
| | Amount (parts | | |
| Ingredient | by weight) | Amount | Amount |
| Adhesion Promoter 1 | 2.29 | 1.67 | 2.29 |
| Adhesion Promoter 2 | 0 | 0.84 | 0 |
| Catalyst 1 | 0.12 | 0 | 0.17 |
| Catalyst 2 | 0 | 0.21 | 0 |
| Chain Extender 1 | 4.00 | 0 | 4.00 |
| Crosslinker 1 | 0.38 | 0 | 0.64 |
| Crosslinker 2 | 2.01 | 2.63 | 1.92 |
| Filler 1 | 0 | 0 | 4.95 |
| Filler 2 | 19.96 | 21.68 | 16.25 |
| Filler 3 | 3.94 | 4.18 | 3.94 |
| Filler Treatment 1 | 0.18 | 0.19 | 0.19 |
| Filler Treatment 2 | 0.04 | 0.04 | 0.03 |
| Filler Treatment 3 | 0 | 0 | 0.02 |
| Filler Treatment 4 | 1.28 | 1.33 | 0.12 |
| Filler Treatment 5 | 0.002 | 0.001 | 0.002 |
| Filler Treatment 6 | 0.02 | 0 | 0.03 |
| Fluid 1 | 0 | 0 | 1.04 |
| Fluid 2 | 0.89 | 0.94 | 12.33 |
| Fluid 3 | 7.64 | 0 | 7.64 |
| Gum 1 | 8.50 | 13.71 | 8.52 |
| Gum 2 | 41.42 | 45.00 | 34.84 |
| Gum 3 | 7.04 | 7.35 | 0.44 |
| Inhibitor 1 | 0 | 0 | 0.01 |
| Inhibitor 2 | 0.15 | 0 | 0.15 |
| Pigment 1 | 0.08 | 0 | 0.08 |
| Pigment 2 | 0 | 0.21 | 0 |
| Stabilizer 1 | 0.007 | 0.01 | 0.01 |

### Examples 1 and 2

### Comparison of Non-Sewn Seams Made with Confined and Unconfined Cure and Comparative Example Made Without Surface Treating

Two 46×46 (46 fibers per inch of warp and 46 fibers per inch of weft) panels of nylon fabric of 470 decitex were used in each example. Each panel had Dow Corning® LCF-4300 (commercially available from Dow Corning Corporation of Midland, Mich., U.S.A.) coated on a surface thereof, at a coat weight of 35 grams/square meter. Each coated surface was treated with corona treatment as per the specified conditions in Run 1, shown in table 2. The power out of the corona treater is expressed in kilowatts (kW). This is the amount of energy used to treat the silicone coated nylon fabric. The line speed was expressed in terms of time through the length of the oven on the coating unit (not heated). The 40 seconds equates to 2.7 feet/minute and the 133 seconds refers to 10 feet/minute fabric line speed during corona treatment. The activation stability refers to the length time the treated coated fabric was allowed to rest before the fabric was used to make the samples on the press to cure. With example 1, 2880 minutes (48 hours) was let pass before samples were made. This means that during this time the corona treatment dissipated before the samples were made as determined by surface dyne measurements using special pens for this purpose.

To prepare example 1, a jig was laid on the coated surface and deaired silicone adhesive composition 1 (prepared in reference example 1) was forced into the straight line void, and a flat edged tool forced the composition in the jig void to form the seam. The back half of the jig was removed and the coated, treated, surface of the second panel was applied. Small amounts of finger pressure were used ensure surface-to-surface contact. The resulting assembly was quickly transferred onto a heated plate and immediately transferred to a heated press at 170° C., and 3 tons pressure was applied for 1 minute to cure. The resulting article was removed from the press and allowed to cool.

Example 2 was prepared as in example 1, except that to provide confined space curing, the back-half of the jig was not removed. The top corona treated coated fabric piece was placed on top of the jig filled flush with seam sealant and wet out with light pressure. The assembly was then placed between two heated plates and placed into the heated press for a 1 minute cure at 170° C. The resulting article was allowed to cool after removal from the press.

Peel strength was measured on a tensometer with a crosshead speed of 200 mm/minute. Peel strength samples were cut into 2 inch wide strips and pulled. Data was recorded in pounds of force (lbf) used to separate the peel strip samples. Instead of percent cohesive measured on the separated peel samples, a percent coating failure was used because coating fabric was removed from the nylon fabric as the mode of failure. The percent coating failure was determined by using a water soluble ink to treat the area with the bead of silicone adhesive. The ink would stay on the nylon coated portion where the coating was removed. This was quantified using a grid system to determine the percent coating failure for each sample. The median sample value for 3 samples was recorded in Table 2.

The comparative example was made and tested as in example 1, except that no corona or other surface treating method was used on the coated fabric. The initial peel strength is recorded in Table 2.

### Examples 3-27

### Corona Treatment Examples

Samples 3 to 27 were prepared using two 46×46 panels of nylon fabric of 470 decitex (420 denier) in each example. Each panel had Dow Corning® LCF-4300 (commercially available from Dow Corning Corporation of Midland, Mich., U.S.A.) coated on a surface thereof, at a coat weight of 35 grams/square meter. Each coated surface was treated with corona treatment as per the specified conditions in Table 3. The power out of the corona treater is expressed in kilowatts (kW). This is the amount of energy used to treat the silicone coated nylon fabric. The line speed was expressed in terms of time through the length of the oven on the coating unit (not heated). The 40 seconds equates to 2.7 feet/minute and the 133 seconds refers to 10 feet/minute fabric line speed during corona treatment. The activation stability refers to the length time the treated coated fabric was allowed to rest before the fabric was used to make the samples on the press to cure. With examples 3, 2880 minutes (48 hours) was let pass before samples were made. This means that during this time the corona treatment dissipated before the samples were made as determined by surface dyne measurements using special pens for this purpose.

To prepare examples 3-27, a jig was laid on the coated surface and deaired silicone adhesive composition 1 (prepared in reference example 1 was forced into the straight line void, and a flat edged tool forced the composition in the jig void to form the seam. The back half of the jig was removed and the coated, treated, surface of the second panel was applied. Small amounts of finger pressure were used ensure surface-to-surface contact. The resulting assembly was quickly transferred onto a heated plate and immediately transferred to a heated press at 170° C., and 3 tons pressure was applied for 1 minute to cure. The resulting article was removed from the press and allowed to cool.

Peel strength was measured on a tensometer with a crosshead speed of 200 mm/minute. Peel strength samples were cut into 2 inch wide strips and pulled. Data was recorded in pounds of force (lbf) used to separate the peel strip samples. Instead of percent cohesive measured on the separated peel samples, a percent coating failure was used because coating fabric was removed from the nylon fabric as the mode of failure. The percent coating failure was determined by using a water soluble ink to treat the area with the bead of silicone adhesive. The ink would stay on the nylon coated portion where the coating was removed. This was quantified using a grid system to determine the percent coating failure for each sample. The median sample value for 3 samples was recorded in Table 4. Peel strength samples were also tested after heat and humidity aging at 70° C. and 95% RH for the duration specified in Table 5. Samples are taken out, equilibrated to room temperature, and then tested with the tensometer as described above.

### Example 28

### Plasma Treatment Example

Plasma treatment was performed on the coated surfaces of fabric panels. The fabric panels were nylon fabric having surfaced coated with Dow Corning® LCF-4300 (commercially available from Dow Corning Corporation of Midland, Mich., U.S.A.), at a coat weight of 35 grams/square meter. Plasma treatment was performed using helium plasma field in a Dow Corning Plasma Solutions SE-2000 PlasmaStream™ System, which is a standalone surface engineering system for the processing of conducting or insulating materials in 3D, rigid sheet, or fiber/filament form available from Dow Corning Corporation. Plasma treatment was performed using the following conditions Power: 100%, Speed: 10, He Flow: 8, Z Gap: 69, and Ari Mist nebulizer installed with an empty syringe.

A bead of silicone adhesive composition 1 prepared in reference example 1 was applied to a panel of the plasma treated, coated fabric. A second panel was put on top of the bead to form an article. The bead was cured by placing the article into a heated press at 170° C. and 5 tons pressure for 10 minutes. Peel strength was evaluated in the same manner as examples 3-27. The results are in Table 6.

### Example 29-43

### Plasma Treatment Samples

Plasma treatment was performed on the coated surfaces of fabric panels. The fabric panels were nylon fabric having surfaced coated with Dow Corning® LCF-4300 (commercially available from Dow Corning Corporation of Midland, Mich., U.S.A.), at a coat weight of 35 grams/square meter. Plasma treatment was performed using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar.

A bead of silicone adhesive composition 1 prepared in reference example 1 was applied to a panel of the plasma treated, coated fabric. A second plasma treated, coated fabric panel was put on top of the bead to form an article. The bead was cured by placing the article into a heated press at 170° C. and 5 tons pressure for 10 minutes. The resulting samples were cut into four 2 inch strips. Peel strengths were evaluated on these samples in the same manner as examples 3-27. The results are in Table 7.

Initial samples were bonded 24 hours after plasma treating. Initial surface energy was measured by Plasmatreat, and 24 hour surface energy was measured as described above for examples 3 to 27.

### Example 44

### Plasma Treating with a Liquid Precursor

Samples were prepared and analyzed as in example 29, except that Plasmatreat's liquid precursor comprising hexamethyldisiloxane was applied to the coated fabric concurrently with plasma treating. The results are in Table 7.

### Examples #45-48

### Plasma Treatment Sample Using Alternative Method for Confined Cure

Plasma treatment was performed on the coated surfaces of fabric panels. The fabric panels were nylon fabric having surface coated with Dow Corning® LCF-4300 (commercially available from Dow Corning Corporation of Midland, Mich., U.S.A.), at a coat weight of 30 grams/square meter. Plasma treatment was performed using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare example #45, a template was laid on a plasma treated, coated surface of fabric and deaired silicone adhesive composition 1 (prepared in reference example 1) was forced into the channel of the template, and a flat edged tool forced the composition in the channel of the template to form the seam. The template was completely removed and a second plasma treated, coated fabric panel was put treated side in contact with seam material. The template used to apply the silicone adhesive composition 1 to the first plasma treated, coated fabric was then place over the channel of seam material on the outside of the second fabric panel. The seam was cured by placing the resulting article with template into a heated press at 177° C. and 20 tons pressure for 10 minutes. The resulting samples were cut into four 2 inch strips. Peel strengths were evaluated on these samples in the same manner as examples 29-43. The results are in Table 8.

Comparative example #46 was made and tested as in example #45, except using coated fabric that had no plasma or other surface treatment. Examples #47 and comparative example #48 were also made and tested as in example #45 on uncoated nylon fabric that was plasma treated and uncoated nylon fabric that was not plasma treated, respectively.

### Examples #49-50

### Plasma Treatment Samples Using Two Beads to Form One

Plasma treatment was performed on the coated surfaces of fabric panels. The fabric panels were nylon fabric having surface coated with Dow Corning® LCF-4300 (commercially available from Dow Corning Corporation of Midland, Mich., U.S.A.), at a coat weight of 30 grams/square meter. Plasma treatment was performed using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare example #49, a template was laid on a plasma treated, coated surface of fabric and deaired silicone adhesive composition 1 (prepared in reference example 1) was forced into the channel of the template, and a flat edged tool forced the composition in the channel of the template to form the seam. The template was removed and placed on a second plasma treated, coated surface of fabric and deaired silicone adhesive composition 1 (prepared in reference example 1) was forced into the channel of the template, and a flat edged tool forced the composition in the channel of the template to form the seam on the second panel of fabric. The second panel of fabric with seam material was aligned seam down to the first panel of fabric with seam material to allow exposed seam material from both panels to contact each other and form one seam of material. A template having twice the thickness as used to apply the seam material on each panel was placed over the seam material on the outside of the second plasma treated, coated fabric. The seam was cured by placing the article with template into a heated press at 177° C. and 20 tons pressure for 10 minutes. The resulting samples were cut into four 2 inch strips. Peel strengths were evaluated on these samples in the same manner as examples 45. The results are in Table 9.

Comparative example #50 was made and tested as in example #49, except that no plasma or other surface treating method was used on the coated fabric.

### Example #51

### Plasma Treatment Samples Using Two Adjacent Beads

Plasma treatment was performed on the coated surfaces of fabric panels. The fabric panels were nylon fabric having surface coated with Dow Corning® LCF-4300 (commercially available from Dow Corning Corporation of Midland, Mich., U.S.A.), at a coat weight of 30 grams/square meter. Plasma treatment was performed using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare example #51, a first panel of fabric was plasma treated on half of the seam dimension by positioning a template over the coated fabric to mask off one half of the seam from plasma treatment. The fabric was then exposed to the plasma treatment. The masking template was removed and a template of half of the total seam width was place over the plasma treated area so that one edge of the channel in the template aligned with the edge of where the non plasma treated surface started such that the plasma treated surface of fabric was exposed through the opening in the template. Deaired silicone adhesive composition 1 (prepared in reference example 1) was forced into the channel of the template, and a flat edged tool forced the composition in the channel of the template to form one bead of the seam. The template was removed and a new template comprising the final width (twice the first seam width) of the seam was positioned so that one edge of the channel in the template aligned with the edge of silicone adhesive composition 1 such that the void space in the channel was open to the untreated portion of fabric coating.

A deaired commercially available silicone adhesive composition (SILASTIC® SE 6750, which is available from Dow Corning Corporation of Midland, Mich., USA) was applied into the channel of the template, and a flat edged tool leveled the composition in the channel of the template to form the second bead of the seam which was adjacent and in contact to the first. The second panel of fabric was plasma treated in the same manner as the first. The second panel of fabric was plasma treated on half of the seam dimension by positioning a template over the coated fabric to mask off one half of the seam from plasma treatment. The fabric was then exposed to the plasma treatment. The masking template was removed and the second, treated panel was aligned over the first panel and adjacent seam materials such that the seam material of silicone composition 1 was in contact with the plasma treated area of the second fabric and the silicone adhesive composition (SE 6750) was in contact with the non plasma treated area of the second fabric. A template having a total width of the adjacent seam materials was then positioned over the seam material on the outside of the second panel of coated fabric. The seam was cured by placing the article with template into a heated press at 177° C. and 20 tons pressure for 10 minutes. The resulting samples were cut into four 2 inch strips. Peel strengths were evaluated on these samples with the peel beginning on the edge that was confined by the template. The results are in Table 10.

### Examples #52-63

### Use of Adhesion Promoter

Samples #52-63 were prepared using two 46×46 (46 fibers per inch of warp and 46 fibers per inch of weft) panels of nylon fabric of 470 decitex (420 denier) in each example. Each panel had Dow Corning® LCF-4300 (commercially available from Dow Corning Corporation of Midland, Mich., U.S.A.) coated on a surface thereof, at a coat weight of 30 grams/square meter. Each coated surface was primed with adhesion promoter as specified in Table 11 by applying the adhesion promoter to a cloth and wiping the cloth with adhesion promoter across the coated fabric twice. Excess primer was then removed from the surface with a clean cloth by wiping twice.

Samples were prepared using no plasma treatment, plasma treatment before adhesion promoter, and plasma treatment after adhesion promoter. Plasma treatment was performed as described in example #45. The peel strip samples were prepared immediately and seven days after primer application. To prepare peel strip samples, a template was laid on the primed and/or treated, coated panel of fabric and deaired silicone adhesive composition 1 (prepared in reference example 1) was forced into the channel of the template, and a flat edged tool forced the composition in the channel of the template to form the seam. The template was completely removed and a second primed and/or treated, coated panel of fabric was placed primed side in contact with seam material. The template used to apply the silicone adhesive composition 1 to the first primed and/or treated, coated panel of fabric was then place over the channel of seam material on the outside of the second primed and/or treated, coated panel of fabric. The seam was cured by placing the article with template into a heated press at 177° C. and 20 tons pressure for 10 minutes. The resulting samples were cut into four 2 inch strips. Peel strengths were evaluated on these samples in the same manner as example #45. The results are in Table 11.

### Examples #64-65

### Using a Heated Dispensing Unit

A Graco Thermo-O-Flow® 5 gallon hot melt pump/dispenser was used to evaluate the pumping and dispensability of silicone adhesive composition 1. Silicone adhesive composition 1 was produced and packaged into a 5 gallon metal container. The container was loaded onto the hot melt pump and pumping trials using the conditions listed in Table 12. Results are also included in Table 12. Results show no indication of material curing.

### Example #66-68

### Applying Bead Using Profiled Tool

Samples #66-68 were prepared using two 46×46 (46 fibers per inch of warp and 46 fibers per inch of weft) panels of nylon fabric of 470 decitex (420 denier) in each example. Each panel had Dow Corning® LCF-4300 (commercially available from Dow Corning Corporation of Midland, Mich., U.S.A.) coated on a surface thereof, at a coat weight of 30 grams/square meter. Each coated surface was plasma treated using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare examples #66 and #67, a template was laid on a plasma treated, coated surface of fabric and deaired silicone adhesive composition 1 (prepared in reference example 1) was forced into the channel of the template using a tool having the profile listed in Table 13 to force the composition in the channel of the template and create a profile to the bead that forms the seam. The profile of seam material was approximately 0.050″ higher than the template surface. One half of the template was moved 5 to 10 mm away from the bead edge while the other half was left in place to provide a confined edge on the seam in between the fabric panels. A second plasma treated, coated panel was put treated side in contact with profile of the seam material. Small amounts of finger pressure were used ensure surface-to-surface contact. The resulting assembly was quickly transferred into a heated press at 177° C. and 20 tons pressure was applied for 10 minutes to cure. The resulting article was removed from the press and allowed to cool. The resulting samples were cut into four 2 inch strips. Peel strengths were evaluated on these samples with the peel beginning on the edge that was confined by the template. The results are in Table 13.

Example #68 was made and tested as in example #66 and #67, except the tool used to force the silicone adhesive composition into the channel of the template utilized a flat edge with no profile.

### Examples #69A and 69B

### Contacting The Seam Material To A Second Surface Using a Vibratory Device

Sample #69A was prepared using two 46×46 (46 fibers per inch of warp and 46 fibers per inch of weft) panels of nylon fabric of 470 decitex (420 denier) in each example. Each panel had Dow Corning® LCF-4300 (commercially available from Dow Corning Corporation of Midland, Mich., U.S.A.) coated on a surface thereof, at a coat weight of 30 grams/square meter. Each coated surface was plasma treated using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare example #69A, a template was laid on a plasma treated, coated surface of fabric and deaired silicone adhesive composition 1 (prepared in reference example 1) was forced into the channel of the template, and a flat edged tool forced the composition in the channel of the template to form the seam. The template was completely removed and a second plasma treated, coated panel was put treated side in contact with seam material. A Dremel (Model 290-01) vibrating engraver with a die having the same dimensions as the channel in the template was used to contact the treated surface of the second fabric panel to the seam material. The Dremel vibration was adjusted to a setpoint of 3 and the vibrating die was moved along the path of the seam material twice. One half of the template was then place on each side of the seam and between the first and second panel of fabric but at least an one half inch away from the edge of the seam to limit compression during curing. The resulting assembly was quickly transferred onto to a heated press at 177° C. and 20 tons pressure was applied for 10 minutes to cure. The resulting article was removed from the press and allowed to cool. The resulting samples were cut into four 2 inch strips. Peel strengths were evaluated on these samples in the same manner as examples 45. The results are in Table 14.

Example #69B was made and tested as in example #69A, except the vibratory tool was not used. The second panel of fabric was applied to the seam by gentle pressing with fingers to contact the treated surface to the seam material. It was cured in the same manner as example #69A with one half of the template on each side of the seam and between the first and second panel of fabric but at least an inch away from the edge of the seam to limit compression during curing.

### Examples #70-75

### Comparison of Different Cure Systems for Silicone Materials

Plasma treatment was performed on the coated surfaces of fabric panels. The fabric panels were nylon fabric having surface coated with Dow Corning® LCF-4300 (commercially available from Dow Corning Corporation of Midland, Mich., U.S.A.), at a coat weight of 30 grams/square meter. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare examples #70, #72, and #74, a template was laid on a plasma treated, coated surface of fabric and the various silicone adhesive composition listed in Table 15 were used to fill the channel of the template, and a flat edged tool forced each composition in the channel of the template to form the seam. The template was completely removed and a second plasma treated, coated panel was put treated side in contact with seam material. The template used to apply the specific silicone adhesive composition to the first plasma treated, coated fabric was then place over the channel of seam material on the outside of the second plasma treated, coated fabric. For silicone adhesive composition 1, a peroxide curable silicone adhesive composition, the seam was cured by placing the article with template into a heated press at 170° C. and 5 tons pressure for 10 minutes. For a hot melt silicone adhesive composition (DOW CORNING® HM-2510, which is commercially available from Dow Corning Corporation of Midland, Mich. USA), the seam was hot pressed at 120° C. for 5 minutes, then transferred to a cooling press for 5 minutes will still confining the seam of material. The article was removed and allowed to cure for 10 days at room temperature and 50% relative humidity. All resulting samples were cut into four 2 inch strips. Peel strengths were evaluated on these samples in the same manner as example #45. The results are in Table 15.

The peroxide curable composition was prepared by mixing the following ingredients: 0.18 parts by weight (pbw) Filler Treatment 1, 0.007 pbw Stabilizer 1, 2.03 pbw Crosslinker 2, 0.04 pbw Filler Treatment 2, 8.33 pbw Gum 1, 0.38 pbw Crosslinker 1, 19.82 pbw Filler 2, 6.66 pbw Gum 3, 41.4 pbw Gum 2, 1.21 pbw Filler Treatment 4, 0.85 pbw Fluid 2, 2.31 pbw Adhesion Promoter 1, 7.72 pbw Fluid 3, 0.08 pbw Pigment 1, 3.86 Filler 3, 4.04 pbw Chain Extender 1, and 1.01 pbw Peroxide 1, and 0.05 pbw ammonia.

Comparative examples #71, #73, and #75 were produced in the same manner as examples #70, #72, and #74, respectively, except that non-plasma treated fabric was used as controls.

### Examples #76-78

### Comparison of Time Between Plasma Treatment and Application

Plasma treatment was performed on the coated surfaces of fabric panels. The fabric panels were nylon fabric having surface coated with Dow Corning® LCF-4300 (commercially available from Dow Corning Corporation of Midland, Mich., U.S.A.), at a coat weight of 30 grams/square meter. Plasma treatment was performed using Plasmatreat's OpenAir system. Plasma treatment was performed using the following system settings: Discharge Voltage: 20 kV, System Current: 3.0 to 3.6 Amps, System Frequency: 17 to 20 kiloHertz (kHz), Duty Cycle: 100%, and Pressure: 2.5 to 3.0 bar, Nozzle height from fabric: 7 mm, linear travel speed: 100 mm/min, Gas Type: Compressed Air.

To prepare example #76, a template was laid on a plasma treated, coated surface of fabric immediately after treatment and deaired silicone adhesive composition 1 (prepared in reference example 1) was forced into the channel of the template, and a flat edged tool forced the composition in the channel of the template to form the seam. The template was completely removed and a second plasma treated, coated panel was put treated side in contact with seam material. The template used to apply the silicone adhesive composition 1 to the first plasma treated, coated fabric was then place over the channel of seam material on the outside of the second plasma treated, coated fabric. The seam was cured by placing the article with template into a heated press at 177° C. and 20 tons pressure for 10 minutes. The resulting samples were cut into four 2 inch strips. Peel strengths were evaluated on these samples in the same manner as example #45. The results are in Table 16.

Example # 77 was produced and tested as in example #76, except the plasma treated fabric was allowed to age for 7 days at room temperature and 45% relative humidity before the silicone adhesive composition was applied to the fabric. All other steps to produce a peel strip and testing were the same.

Comparative example #78 was produced and tested as in example #76, except the fabric was not plasma treated. All other steps to produce a peel strip and testing were the same.

### Examples #79-83

### Assembly of Mini Airbags and Deployment Data Comparison

Two 46×46 (46 fibers per inch of warp and 46 fibers per inch of weft) panels of nylon fabric of 470 decitex were used to produce a mini airbag. Each panel had Dow Corning® LCF-4300 (commercially available from Dow Corning Corporation of Midland, Mich., U.S.A.) coated on a surface thereof, at a coat weight of 30 grams/square meter. The coated surface of each panel was prepared as described in Table 17. When plasma treatment was required, the fabric was treated using plasma treatment conditions described in example #45, a template having a channel that resulted in a mini airbag shape was laid on the prepared fabric panel and deaired silicone adhesive composition 1 (prepared in reference example 1) was forced into the channel of the template, and a flat edged tool forced the composition in the channel of the template to form the seam. The template was completely removed and a second coated panel prepared identical to the first coated panel was put coated side in contact with seam material. The template used to apply the silicone adhesive composition 1 to the first coated and/or treated surface fabric was then place over the channel of seam material on the outside of the second coated and/or treated fabric. The seam was cured by placing the article with template into a heated press at 177° C. and 20 tons pressure for 10 minutes. The mini airbag assembly was removed from the press and allowed to condition for one day. The mini airbag assemblies were then tested by deploying on a Dow Corning cold gas airbag deployment tester. Four airbags were produced for each example and burst values for the construction of each example were determined by gradually increasing the inflation pressure setpoint of each deployment until a pressure was reach in which rupture of the seam material occurred and the mini airbag could no longer hold air. At this point, the inflation pressure setpoint was reduced 20 kPa and a new mini airbag was deployed. If the airbag survived deployment at this new setpoint, the setpoint was raised 10 kPa. If the airbag did not survive deployment, the inflation pressure setpoint was reduced another 20 kPa. This process was repeated until all four mini airbags for each sample were deployed and failure reached. The maximum peak pressure before failure was determined by recording the maximum pressure obtained on an airbag that did not fail during deployment. Results are documented in table 17.

TABLE 2
Corona Conditions and Results

| | | | | | | | | Avg. | 1 | 1 | | |
|---|---|---|---|---|---|---|---|---|---|---|---|---|
| | | | | | | Press | Init. | Initial | week | month | Initial | 1 month |
| | Power | Line | Activation | Press | Initial | Time | Peel | Peel | Peel | Peel | Coating | Coating |
| | Output | Speed | Stability | Time | Energy | Energy | Strength | Str | Str | Str | Failure | Failure |
| Example | (kW) | (s) | (min) | (min) | (dyne) | (dyne) | (lbf) | (lbf) | (lbf) | (lbf) | (%) | (%) |
| 1 - confined | 0.06 | 40 | 2880 | 1 | 30 | 30 | 106.1 | 106.5 | 106.9 | 94.8 | 10 | 10 |
| cure | | | | | | | | | | | | |
| 2 - | 0.06 | 40 | 2880 | 1 | 30 | 30 | 106.2 | 106.6 | 122.5 | 117.3 | 70 | 95 |
| unconfined | | | | | | | | | | | | |
| cure | | | | | | | | | | | | |
| Comparative - | n/a | n/a | n/a | 1 | | | 69.1 | | | | | |
| unconfined | | | | | | | | | | | | |
| cure | | | | | | | | | | | | |

TABLE 3
Corona Treating and Run Conditions

| | A: | B: Line | C: Activation | D: Press |
|---|---|---|---|---|
| | Poweroutput | speed | Stablity | Time |
| Run | kw | sec | min. | min. |
| 3 | 0.06 | 40 | 2880 | 1 |
| 4 | 0.06 | 40 | 2880 | 1 |
| 5 | 0.51 | 40 | 2880 | 10 |
| 6 | 0.51 | 40 | 2880 | 10 |
| 7 | 0.51 | 86.5 | 2880 | 1 |
| 8 | 0.51 | 40 | 1445 | 1 |
| 9 | 0.06 | 40 | 1445 | 10 |
| 10 | 0.285 | 40 | 1445 | 5.5 |
| 11 | 0.06 | 86.5 | 1445 | 5.5 |
| 12 | 0.51 | 86.5 | 1445 | 5.5 |
| 13 | 0.51 | 133 | 10 | 1 |
| 14 | 0.06 | 133 | 10 | 10 |
| 15 | 0.51 | 133 | 10 | 1 |
| 16 | 0.51 | 40 | 10 | 10 |
| 17 | 0.06 | 40 | 10 | 1 |
| 18 | 0.06 | 133 | 2880 | 10 |
| 19 | 0.285 | 86.5 | 2162.5 | 5.5 |
| 20 | 0.06 | 133 | 2880 | 10 |
| 21 | 0.285 | 133 | 2880 | 1 |
| 22 | 0.51 | 133 | 2880 | 5.5 |
| 23 | 0.51 | 133 | 1445 | 10 |
| 24 | 0.51 | 40 | 10 | 10 |
| 25 | 0.285 | 133 | 1445 | 5.5 |
| 26 | 0.06 | 133 | 1445 | 1 |
| 27 | 0.285 | 86.5 | 10 | 5.5 |

TABLE 4
Results

| | Initial | Press Time | | | | 1 month Peel | Init. Coating | 1 month Coating |
|---|---|---|---|---|---|---|---|---|
| | Energy | Energy | Init. Peel Str. | Avg. Init. Peel | 1 wk Peel Str. | Str. | Fail | Failure |
| Run | dynes | dynes | lb_{f} | lb_{f} | lb_{f} | lb_{f} | % | % |
| 3 | 30 | 30 | 106.12 | 106.54 | 106.94 | 94.82 | 10 | 10 |
| 4 | 30 | 30 | 84.36 | 84.2 | 95.44 | 93.18 | 7 | 8 |
| 5 | 70 | 30 | 105 | 108.3 | 101.5 | 105.82 | 8 | 15 |
| 6 | 70 | 30 | 104.54 | 102.64 | 102.08 | 117.12 | 15 | 16 |
| 7 | 66 | 32 | 87.2 | 88.82 | 101.18 | 105.6 | 3 | 33 |
| 8 | 70 | 32 | 85.1 | 81.02 | 104.84 | 92.96 | 5 | 7 |
| 9 | 32 | 30 | 105.96 | 105.92 | 111.12 | 96.7 | 4 | 5 |
| 10 | 42 | 30 | 81.88 | 81.98 | 80 | 117.04 | 1 | 23 |
| 11 | 30 | 30 | 106.12 | 108.46 | 104.92 | 116.6 | 1 | 20 |
| 12 | 70 | 32 | 101.78 | 101.6 | 104.02 | 110.3 | 10 | 35 |
| 13 | 70 | 70 | 94 | 97.96 | 109.48 | 96.7 | 10 | 5 |
| 14 | 60 | 60 | 83.24 | 81.86 | 78.96 | 78.3 | 7 | 15 |
| 15 | 70 | 70 | 92.74 | 87.22 | 104.24 | 101.78 | 20 | 20 |
| 16 | 70 | 70 | 103.42 | 105.02 | 108.74 | 99.62 | 25 | 27 |
| 17 | 30 | 30 | 104.1 | 105.54 | 101.92 | 103.44 | 21 | 37 |
| 18 | 56 | 32 | 92.72 | 93.4 | 97.76 | 94.08 | 3 | 10 |
| 19 | 66 | 34 | 90.78 | 106.04 | 92.2 | 94.6 | 5 | 7 |
| 20 | 58 | 30 | 95.66 | 93.48 | 97.52 | 100.44 | 8 | 5 |
| 21 | 70 | 32 | 95.88 | 114.5 | 98.48 | 107.02 | 10 | 13 |
| 22 | 70 | 30 | 101.56 | 99.08 | 100.32 | 99.32 | 8 | 36 |
| 23 | 70 | 30 | 113.6 | 114.1 | 105.88 | 102.9 | 25 | 20 |
| 24 | 62 | 60 | 94.98 | 96.76 | 107.38 | 103.26 | 10 | 10 |
| 25 | 70 | 30 | 103.06 | 103.3 | 112.92 | 104.54 | 30 | 37 |
| 26 | 56 | 30 | 76.14 | 79.38 | 88.68 | 90.78 | 5 | 10 |
| 27 | 64 | 62 | 83.52 | 84.56 | 85.4 | 93.32 | 2 | 2 |

TABLE 5
Heat and Humidity Aging Study

| | | | Heat/Hum- | Heat/Hum- | Heat/Hum- | | |
|---|---|---|---|---|---|---|---|
| | Heat/Hum. Peel | Heat/Hum. | Peel Str.- | CoatFaill- | CoatFail- | 408 hr/105 C.- | 408 hrs/105 C.- |
| | Str.-408 hrs | Peel-625 hrs | 1000 hrs | 408 hrs | 1000 hrs | Peel Str. | CoatFail |
| Example | lbf. | lbf | lbf | % | % | lbf | % |
| 3 | 59.08 | 57.52 | 50.62 | 10 | 10 | 76.22 | 50 |
| 4 | 56.08 | 56.16 | 57.44 | 5 | 10 | 74.42 | 55 |
| 5 | 77.62 | 51.98 | 46.74 | 10 | 15 | 96.48 | 55 |
| 6 | 71.26 | 53.48 | 44.2 | 5 | 10 | 86.68 | 50 |
| 7 | 74.4 | 76.7 | 73.06 | 10 | 15 | 83.9 | 50 |
| 8 | 79.72 | 76.12 | 79.64 | 30 | 10 | 99.16 | 45 |
| 9 | 55.2 | 54.88 | 28.78 | 25 | 25 | 79.28 | 35 |
| 10 | 83.08 | 48.82 | 30.12 | 30 | 20 | 78.9 | 45 |
| 11 | 71.58 | 45.76 | 43.88 | 25 | 25 | 72.54 | 75 |
| 12 | 53.18 | 42.4 | 31.4 | 12 | 20 | 84.66 | 40 |
| 13 | 110.16 | 35.74 | 77.18 | 10 | 27 | 93.92 | 20 |
| 14 | 34.96 | 35.74 | 26.4 | 10 | 25 | 66.42 | 45 |
| 15 | 104.16 | 90.04 | 81.96 | 20 | 20 | 90.64 | 5 |
| 16 | 84.06 | 48.6 | 48.76 | 20 | 25 | 83.76 | 50 |
| 17 | 99.24 | 98.5 | 85.32 | 10 | 25 | 89.66 | 45 |
| 18 | 60.28 | 53.2 | 31.26 | 15 | 15 | 75.16 | 55 |
| 19 | 78.6 | 33.44 | 48.6 | 25 | 30 | 63.78 | 55 |
| 20 | 49.72 | 50.94 | 26.86 | 15 | 30 | 69.32 | 65 |
| 21 | 104.54 | 74.94 | 57.06 | 10 | 25 | 91 | 25 |
| 22 | 55.4 | 48.62 | 48.84 | 35 | 25 | 81.5 | 30 |
| 23 | 78.28 | 67.36 | 45.02 | 30 | 25 | 84.04 | 50 |
| 24 | 91.68 | 71.04 | 55.86 | 30 | 30 | 83.68 | 50 |
| 25 | 59.36 | 66.62 | 58.48 | 25 | 20 | 81.06 | 40 |
| 26 | 75.38 | 74.92 | 57.88 | 25 | 20 | 76.34 | 20 |
| 27 | 54.58 | 42.54 | 27 | 35 | 15 | 64.52 | 55 |

TABLE 6
Gaseous Plasma treatment using Dow Corning plasma system

| | Initial Peel Peak | Initial Peel Peak | Initial % Coating |
|---|---|---|---|
| | Value (Lb_{f} /in²) | Value (Lb_{f}) | Cohesive Failure |
| 28-1 | 69.2 | 138.4 | 70 |
| 28-2 | 65.0 | 129.9 | 70 |
| 28-3 | 70.9 | 141.8 | 70 |
| 28-4 | 66.5 | 133.0 | 60 |
| Average | 67.9 | 135.8 | |

TABLE 7
Plasma Treatment Results

| | | Surf | | | | | | | | | | |
|---|---|---|---|---|---|---|---|---|---|---|---|---|
| | Surf | Eng | | | | | | | | | | |
| | Eng | (1445 | Peak | Peak | Peak | Peak | | | | | | |
| | (dyne | min. | Force | Force | Force | Force | Avg | | % Loss | % | Nozzle | Nozzle |
| | cm2) | press | (run | (run 2) | (run 3) | (run 4) | Peak | St | From | Cohesive | Speed | Height |
| | Initial | time) | 1) Lb F | Lb F | Lb F | Lb F | Force | Dev | Initial | Failure | (mm/sec) | (mm) |
| Example 29 | 30 | <30 | | | | | | | | | 400 | 12 |
| Initial | | | 103.4 | 102.2 | 90.9 | 92.8 | 97.3 | 6.4 | | 2-5 | | |
| Heat aging 400 hrs 107 C. | | | 57.2 | 34.8 | 37.7 | 50.1 | 45.0 | 10.5 | 53.8 | | | |
| Heat and humidity aging | | | 82.6 | 81.7 | 82.9 | 87.4 | 83.6 | 2.6 | 14.1 | | | |
| 400 hrs 70 C., 95% RH | | | | | | | | | | | | |
| Example 30 | 38 | 34 | | | | | | | | | 100 | 12 |
| Initial | | | 92.4 | 103.2 | 96.2 | 94.9 | 96.7 | 4.6 | | 2-5 | | |
| 400 hrs 107 C. | | | 50.5 | 56.9 | 48.1 | 59.3 | 53.7 | 5.3 | 44.5 | | | |
| 400 hrs 70 C., 95% RH | | | 58.6 | 41.2 | 63.0 | 59.2 | 55.5 | 9.7 | 42.6 | | | |
| Example 31 | 30 | <30 | | | | | | | | | 250 | 12 |
| Initial | | | 106.3 | 102.5 | 106.0 | 108.2 | 105.7 | 2.4 | | 2 | | |
| 400 hrs 107 C. | | | 37.3 | 39.5 | 33.1 | 30.6 | 35.1 | 4.0 | 66.8 | | | |
| 400 hrs 70 C., 95% RH | | | 48.8 | 42.1 | 37.8 | 33.8 | 40.6 | 6.4 | 61.6 | | | |
| Example 32 | 40 | 34 | | | | | | | | | 250 | 4 |
| Initial | | | 108.8 | 94.0 | 105.0 | 104.6 | 103.1 | 6.4 | | 0 | | |
| 400 hrs 107 C. | | | 54.6 | 59.2 | 58.5 | 63.3 | 58.9 | 3.6 | 42.9 | | | |
| 400 hrs 70 C., 95% RH | | | 55.9 | 66.4 | 56.0 | 70.3 | 62.2 | 7.3 | 39.7 | | | |
| Example 33 | 36 | <30 | | | | | | | | | 250 | 8 |
| Initial | | | 95.9 | 95.2 | 95.0 | 95.6 | 95.5 | 0.4 | | 2-10 | | |
| 400 hrs 107 C. | | | 55.3 | 53.9 | 71.9 | 68.0 | 62.3 | 9.0 | 34.8 | | | |
| 400 hrs 70 C., 95% RH | | | 53.8 | 42.4 | 47.5 | 52.0 | 48.9 | 5.1 | 48.8 | | | |
| Example 34 | 30 | <30 | | | | | | | | | 400 | 12 |
| Initial | | | 102.7 | 100.7 | 93.3 | 110.9 | 101.9 | 7.2 | | 2-5 | | |
| 400 hrs 107 C. | | | 37.3 | 41.6 | 36.1 | 36.4 | 37.9 | 2.5 | 62.8 | | | |
| 400 hrs 70 C., 95% RH | | | 30.7 | 41.2 | 39.4 | 36.8 | 37.0 | 4.6 | 63.7 | | | |
| Example 35 | 38 | 34 | | | | | | | | | 100 | 12 |
| Initial | | | 108.0 | 104.8 | 108.7 | 104.2 | 106.4 | 2.2 | | 2 | | |
| 400 hrs 107 C. | | | 38.2 | 42.4 | 74.3 | 37.6 | 48.1 | 17.6 | 54.8 | | | |
| 400 hrs 70 C., 95% RH | | | 39.6 | 63.9 | 38.1 | 39.3 | 45.3 | 12.5 | 57.5 | | | |
| Example 36 | 72 | 56 | | | | | | | | | 100 | 4 |
| Initial | | | 101.5 | 99.6 | 103.2 | 94.0 | 99.6 | 4.0 | | 2-5 | | |
| 400 hrs 107 C. | | | 64.8 | 76.1 | 50.4 | 59.7 | 62.7 | 10.7 | 37.0 | | | |
| 400 hrs 70 C., 95% RH | | | 72.9 | 68.1 | 62.4 | 66.6 | 67.5 | 4.4 | 32.2 | | | |
| Example 37 | 44 | 42 | | | | | | | | | 100 | 8 |
| Initial | | | 120.8 | 95.9 | 101.0 | 119.5 | 109.3 | 12.7 | | 5-15 | | |
| 400 hrs 107 C. | | | 70.8 | 76.7 | 79.4 | 69.3 | 74.1 | 4.8 | 32.2 | | | |
| 400 hrs 70 C., 95% RH | | | 77.5 | 72.2 | 69.2 | 63.0 | 70.5 | 6.0 | 35.5 | | | |
| Example 38 | 32 | <30 | | | | | | | | | 400 | 8 |
| Initial | | | 98.6 | 94.7 | 87.6 | 90.6 | 92.9 | 4.8 | | 1-5 | | |
| 400 hrs 107 C. | | | 26.0 | 42.3 | 41.8 | 25.6 | 33.9 | 9.4 | 63.5 | | | |
| 400 hrs 70 C., 95% RH | | | 43.2 | 43.2 | 52.7 | 44.6 | 45.9 | 4.6 | 50.5 | | | |
| Example 39 | 50 | 30 | | | | | | | | | 400 | 4 |
| Initial | | | 109.8 | 103.0 | 98.6 | 119.6 | 107.7 | 9.2 | | 5-25 | | |
| 400 hrs 107 C. | | | 55.2 | 36.6 | 38.5 | 46.2 | 44.1 | 8.5 | 59.0 | | | |
| 400 hrs 70 C., 95% RH | | | 36.5 | 49.4 | 50.9 | 56.0 | 48.2 | 8.3 | 55.2 | | | |
| Example 40 | 50 | 30 | | | | | | | | | 400 | 4 |
| Initial | | | 105.8 | 107.8 | 109.9 | 133.9 | 114.3 | 13.2 | | 5-30 | | |
| 400 hrs 107 C. | | | 66.2 | 52.3 | 58.0 | 62.6 | 59.8 | 6.0 | 47.7 | | | |
| 400 hrs 70 C., 95% RH | | | 50.5 | 44.3 | 42.1 | 51.7 | 47.2 | 4.7 | 58.8 | | | |
| Example 41 | >72 | <30 | | | | | | | | | 50 | 4 |
| Initial | | | 113.4 | 105.2 | 115.9 | 124.5 | 114.8 | 7.9 | | 2-30 | | |
| 400 hrs 107 C. | | | 69.5 | 69.0 | 92.2 | 70.3 | 75.3 | 11.3 | 34.4 | | | |
| 400 hrs 70 C., 95% RH | | | 64.2 | 76.2 | 54.3 | 75.3 | 67.5 | 10.4 | 41.2 | | | |
| Example 42 | >72 | 30 | | | | | | | | | 100 | 4 |
| Initial | | | 104.8 | 115.7 | 124.6 | 105.7 | 112.7 | 9.4 | — | 2-30 | | |
| 400 hrs 107 C. | | | | | | | — | — | | | | |
| 400 hrs 70 C., 95% RH | | | | | | | — | — | | | | |
| Example 43 | >72 | 34 | | | | | | | | | 100 | 4 |
| Initial | | | 110.52 | 105.52 | 96.18 | 122.28 | 108.6 | 10.9 | — | 2-15 | | |
| 400 hrs 107 C. | | | | | | | — | — | | | | |
| 400 hrs 70 C., 95% RH | | | | | | | — | — | | | | |
| Example 44 | >72 | 50 | | | | | | | | | 10 m/min | 16 |
| Initial | | | 125.48 | 108.14 | 108.88 | 127.66 | 117.5 | 10.5 | | 20-70 | | |
| 400 hrs 107 C. | | | 68.5 | 74.04 | 64.92 | 70.14 | 69.4 | 3.8 | 41.0 | | | |
| 400 hrs 70 C., 95% RH | | | 52.58 | 80.46 | 73.28 | 64.98 | 67.8 | 12.0 | 42.3 | | | |

TABLE 8

| | Peak Force | Peak Force | Peak Force | Peak Force | Avg Peak | |
|---|---|---|---|---|---|---|
| | (run 1) Lb F | (run 2) Lb F | (run 3) Lb F | (run 4) Lb F | Force | St Dev |
| Example #45 | | | | | | |
| Initial | 136 | 143 | 144 | 149 | 143 | 5.6 |
| Heat and Humidity Aging | 56 | 46 | 49 | 53 | 51 | 4.5 |
| 408 hrs 70 C., 95% RH | | | | | | |
| Example 46 Comparative | | | | | | |
| Untreated, Confined | | | | | | |
| Initial | 168 | 143 | 156 | 162 | 157 | 10.7 |
| 408 hrs 70 C., 95% RH | 6 | 9 | 7 | 8 | 8 | 1.7 |
| Example 47 Treated, Uncoated, Confined | | | | | | |
| Initial | 40 | 46 | 49 | 55 | 47 | 6.3 |
| 408 hrs 70 C., 95% RH | 73 | 96 | 59 | 84 | 78 | 15.6 |
| Example 48 Comparative | | | | | | |
| Untreated, Uncoated, Confined | | | | | | |
| Initial | 97 | 77 | 126 | 117 | 104 | 21.8 |
| 408 hrs 70 C., 95% RH | 100 | 100 | 109 | 117 | 107 | 8.3 |

TABLE 9

| | Peak | Peak | Peak | Peak | | |
|---|---|---|---|---|---|---|
| | Force | Force | Force | Force | Avg | |
| | (run 1) | (run 2) | (run 3) | (run 4) | Peak | St |
| | Lb F | Lb F | Lb F | Lb F | Force | Dev |
| Example #49 | | | | | | |
| Initial | 152 | 129 | 161 | 144 | 147 | 13.6 |
| Example #50 | | | | | | |
| Comparative | | | | | | |
| Untreated, Confined | | | | | | |
| Initial | 143 | 103 | 86 | 140 | 118 | 27.9 |

TABLE 10

| | Peak | Peak | | | | |
|---|---|---|---|---|---|---|
| | Force | Force | | | Avg | |
| | (run 1) | (run 2) | Peak Force | Peak Force | Peak | St |
| | Lb F | Lb F | (run 3) Lb F | (run 4) Lb F | Force | Dev |
| Example | | | | | | |
| 51 | | | | | | |
| Initial | 145 | 146 | 142 | 162 | 149 | 9.1 |

TABLE 11

| | | | | | 408 hrs |
|---|---|---|---|---|---|
| | | | | | 70° C., 95% |
| | | | | Initial | Humidity |
| | Plasma | Adhesion | Sample | Avg Peak | Avg |
| | Treatment | Promoter | Prep | Force | Peak Force |
| Example 52 | Before | AP 1 | 0 Days | 150 | 46 |
| Example 53 | Before | AP 1 | 7 Days | 153 | 51 |
| Example 54 | Before | AP 2 | 0 Days | 172 | 8 |
| Example 55 | Before | AP 2 | 7 Days | 143 | 29 |
| Example 56 | After | AP 1 | 0 Days | 84 | 22 |
| Example 57 | After | AP 1 | 7 Days | 153 | 139 |
| Example 58 | After | AP 2 | 0 Days | 27 | 8 |
| Example 59 | After | AP 2 | 7 Days | 33 | 30 |
| Example 60 | None | AP 1 | 0 Days | 85 | 8 |
| Example 61 | None | AP 1 | 7 Days | 12 | 5 |
| Example 62 | None | AP 2 | 0 Days | 45 | 3 |
| Example 63 | None | AP 2 | 7 Days | 46 | 59 |

TABLE 12

| | | | | | | | Pump Rate |
|---|---|---|---|---|---|---|---|
| | | | | | | Follower Plate | (Grams per |
| | Ram Pressure | Pump Pressure | Pump Ratio | Exit Orifice | Pump Temp | Temp | minute) |
| Example 64A | 50 psi | 20 psi | ~60:1 | 0.250″ Dia | 158 F. | 169 F. | 154 |
| Example 64B | 50 psi | 20 psi | ~60:1 | 0.250″ Dia | 158 F. | 169 F. | 136 |
| Example 64C | 50 psi | 20 psi | ~60:1 | 0.250″ Dia | 158 F. | 169 F. | 148 |
| Example 65A | 50 psi | 20 psi | ~60:1 | 0.250″ Dia | 196 F. | 190 F. | 183.5 |
| Example 65B | 50 psi | 20 psi | ~60:1 | 0.250″ Dia | 196 F. | 190 F. | 166 |
| Example 65C | 50 psi | 20 psi | ~60:1 | 0.250″ Dia | 196 F. | 190 F. | 165.6 |

TABLE 13

| | | Peak | Peak | Peak | Peak | |
|---|---|---|---|---|---|---|
| | | Force | Force | Force | Force | |
| | | (run 1) | (run 2) | (run 3) | (run 4) | Avg Peak |
| | Profile | Lb F | Lb F | Lb F | Lb F | Force |
| Example 66 | Curve | 124 | 135 | 122 | 133 | 128 |
| Example 67 | Triangle | 121 | 122 | 119 | 123 | 121 |
| Example 68 | Flat | 139 | 143 | 140 | 130 | 138 |

TABLE 14

| | Peak | Peak | Peak | Peak | Initial | |
|---|---|---|---|---|---|---|
| | Force | Force | Force | Force | Avg | |
| | (run 1) | (run 2) | (run 3) | (run 4) | Peak | |
| | Lb F | Lb F | Lb F | Lb F | Force | St Dev |
| Example 69A | 121 | 115 | 93 | 64 | 98 | 25.8 |
| Example 69B | 49 | 47 | 47 | 60 | 51 | 6.1 |
| (no vibratory | | | | | | |
| tool) | | | | | | |

TABLE 15

| | Silicone | | Avg |
|---|---|---|---|
| | Adhesive | | Peak |
| | Composition | Treatment | Force |
| Example 70 | 1 | Plasma | 130 |
| Example 71 Comparative Control-no plasma | 1 | None | 147 |
| Example 72 (Peroxide curable silicone adhesive composition) | 2 | Plasma | 161 |
| Example 73 Comparative Control-no plasma | 2 | None | 147 |
| Example 74 (Hot Melt adhesive composition) | 3 | Plasma | 86 |
| Example 75 ComparativeControl-no plasma | 3 | None | 71.6 |

TABLE 16

| | | Time between | Initial | 408 hrs 70 C./95% |
|---|---|---|---|---|
| | Silicone | Plasma Treatment | Peak | Humidity |
| | Adhesive | and application | Force | Peak Force |
| Table #16 | Composition | of silicone | Lb F | Lb F |
| Example 76 with plasma | 1 | Immediately | 150 | 125 |
| Example 77 with plasma | 1 | 7 Days | 148 | 112 |
| Example 78 Comparative-no plasma | 1 | No Plasma | 166 | 104 |

TABLE 17

| | | | | | 408 hrs 70 C., 95% |
|---|---|---|---|---|---|
| | | | | Max | Humidity |
| | | | | Peak Pressure | Max Peak Pressure |
| | | Adhesion | | Before Failure | Before Failure |
| | Plasma Treatment | Promoter | Sample Prep | (kPa) | (kPa) |
| Example 79 | None | None | 0 Days | 71.72 | |
| (comparative) | | | | | |
| Example 80 | Standard | None | 0 Days | 206.6 | 64.3 |
| Example 81 | Standard | None | 7 Days | 199.09 | 101.68 |
| Example 82 | After Adhesion | AP1 | 0 Days | 188.8 | 125.1 |
| | Promoter | | | | |
| Example 83 | After Adhesion | AP 1 | 7 Days | 204.8 | 195.1 |
| | Promoter | | | | |

### INDUSTRIAL APPLICABILITY

The process described above is useful for preparing non-sewn seams. The processes may reduce costs for assembling articles in a wide variety of applications by reducing or eliminating the need for sewing seams with threads or yarns. The process for preparing non-sewn seams finds use in various applications, such as tents, awnings, inflatable toys, rafts, safety chutes for aircraft, automobile soft tops, architectural fabrics, banners, conveyor belting applications, and airbags.

The airbags described above are useful in automobile applications such as driver's seat, front passenger's seat, rear passenger's seat, side impact, kneebag, pedestrian, and inflatable curtain; as well as other applications such as aircraft airbag passive restraints. For example, the process and silicone composition described above may be used to replace sewn seams to assemble the airbags disclosed in U.S. Pat. No. 6,886,857.

The process described above may replace sewn seams with silicone materials that provide sufficient bonding strength to offset need for mechanical strength through sewing. The process and silicone composition described herein may provide the advantages of: high peel strength of complete system seams; low pressure loss with time as compared to airbags not made with the combination of hot melt adhesive and seam sealant described herein; meeting requirements for folding and packing (fold-ability and pack-ability), and other airbag requirements; flexibility on handling and cure of the system; and process times that may be 3 minutes per airbag, or less.

The process and silicone composition described herein may provide the benefits of: improving process efficiency to assemble airbags because mechanical bonding and sealing are combined; reducing the amount of seam sealant as compared to sewn airbags; improving holdup performance with an integral silicone system; and eliminating damage to fibers in airbag fabric from sewing.

1. A process comprising:
i) surface treating a first surface of a first textile to form a treated first surface,
ii) applying a first bead of a first adhesive composition to the treated first surface of the first textile,
iii) contacting the first bead of the first adhesive composition with a second surface of a second textile, and
iv) forming a non-sewn seam comprising a first adhesive material from the first adhesive composition,
thereby adhering the first textile and the second textile through the non-sewn seam.

2. A process comprising:
i) surface treating a first surface of a first textile to form a treated first surface, surface treating a second surface of a second textile to form a treated second surface, or both;
ii) applying a first bead of a first adhesive composition to the treated first surface of the first textile;
iii) applying a second bead of a second adhesive composition to the treated second surface;
iv) contacting a first exposed surface of the first bead and a second exposed surface of the second bead to form one bead; and
v) forming a non-sewn seam from the one bead;
thereby adhering the first textile and the second textile through the non-sewn seam.

3. A process comprising:
i) surface treating a first surface of a first textile to form a treated first surface;
ii) surface treating a second surface of a second textile to form a treated second surface;
iii) applying a first bead of a first adhesive composition to the treated first surface;
iv) applying a second bead of a second adhesive composition to the treated first surface or the treated second surface such that the second bead is adjacent the first bead during or after step v); and
v) forming a non-sewn seam comprising a first adhesive material prepared from the first adhesive composition and a second adhesive material prepared from the second adhesive composition;
thereby adhering the first textile and the second textile together through the non-sewn seam.

4. A process comprising:
i) surface treating a first surface of a first textile to form a treated first surface, surface treating a second surface of a second textile to form a treated second surface, or both;
ii) applying one bead of adhesive composition to the treated first surface;
iii) contacting the one bead and the treated second surface; and
iv) forming a non-sewn seam from the one bead;
thereby adhering the first textile and the second textile together through the non-sewn seam.

5. The process of claim 1, where the first textile comprises a first airbag component and the second textile comprises a second airbag component.

6. The process of claim 1, further comprising before step i) coating the first surface, the second surface, or both, with a composition selected from a silicone emulsion, a high consistency rubber, a liquid silicone rubber composition, an aerosolized silicone rubber, a powdered silicone rubber, a melted silicon resin, or a silicone modified organic composition.

7. The process of claim 1, further comprising applying an adhesion promoter to the first surface, the second surface, or both.

8. The process of claim 1, where surface treating is performed by plasma treating.

9. The process of claim 1, further comprising storing the first textile after surface treating and before applying, storing the second textile after surface treating and before applying, or both.

10. The process of claim 1, where surface treating and applying are performed concurrently.

11. The process of claim 1, where applying is performed by a method comprising using a template to form the first bead into a desired shape

12. The process of claim 4, where applying is performed by a method comprising using a template to form the one bead into a desired shape.

13. The process of claim 1, where the first adhesive composition is a first silicone composition.

14. The process of claim 4, where the adhesive composition is a silicone composition.

15. The process of claim 13 where the first silicone composition is selected from a moisture curable polyorganosiloxane composition, a hydrosilylation curable polyorganosiloxane composition, or a peroxide curable organopolysiloxane composition.

16. The process of claim 14, where the silicone composition is selected from a moisture curable polyorganosiloxane composition, a hydrosilylation curable polyorganosiloxane composition, or a peroxide curable organopolysiloxane composition.

17. The process of claim 13, where the first silicone composition is a dual cure composition.

18. The process of claim 14, where the silicone composition is a dual cure composition.

19. The process of claim 1, further comprising surface treating the second surface of the second textile to form a second treated surface before step iii).

20. The process of claim 19, where contacting is performed by a method comprising pressing the treated second surface onto the first bead.

21. The process of claim 19, where contacting is performed by a method comprising exposure to an energy wave or a vibratory device.

22. The process of claim 1, where forming the non-sewn seam is performed by a method comprising heating by microwave exposure.

23. The process of claim 1, where forming the non-sewn seam is performed by a method comprising heating in a confined die.

24. The process of claim 2, where the first bead has a first thickness and a first exposed surface opposite the first treated surface, the second bead has a second thickness and a second exposed surface opposite the second treated surface, and step iv) is performed by a method comprising aligning the first exposed surface and the second exposed surface such that the one bead formed by contacting the first bead and the second bead has a thickness greater than the first thickness and/or the second thickness.

25. A non-sewn seam prepared with the process of claim 1.
